(19) United States
(12) Patent Application Publication
(10) Pub. No.: US 2026/0274581 A1
(43) Pub. Date: Sep. 17, 2026

(54) BI-DIRECTIONAL ROLLER AND CONVEYOR

(71) Applicant: Lewco, Inc., Sandusky, OH (US)

(72) Inventors: Gerald T. Guerra, Sandusky, OH (US); Anthony Joseph Oehlman, Perrysburg, OH (US); Ryan Kenny, Richmond, VA (US)

(21) Appl. No.: 19/560,823

(22) Filed: Mar. 9, 2026

Related U.S. Application Data
(60) Provisional application No. 63/772,963, filed on Mar. 17, 2025.

(51) Int. Cl. B65G 39/04; B65G 13/00

(52) U.S. Cl. CPC B65G 39/04; B65G 13/00

(57) ABSTRACT

A roller comprising wheels to enable bi-direction movement of packages and a conveyor incorporating the same. The roller has an axis of rotation extending along a length of the roller. The roller includes the wheels disposed at positions along the length of the roller. Axes of rotation of the wheels of the roller are perpendicular to the axis of rotation of the roller. In various embodiments, adjacent wheels along the length of the roller can be circumferentially offset relative to each other.

### RELATED APPLICATION

This application claims priority to U.S. Provisional Patent Application No. 63/772,963, filed on Mar. 17, 2025, and entitled “BI-DIRECTIONAL ROLLER AND CONVEYOR,” the entirety of which is incorporated herein by reference.

### TECHNICAL FIELD

The present application relates generally to a roller for use with a conveyor system and, more particularly, to a roller for use with a conveyor system configured to facilitate bi-directional movement of packages.

### BACKGROUND OF THE INVENTION

In conveyor systems, one or more packages are conveyed along one or more conveyors. Generally, the one or more packages move along a conveyance or flow direction of the conveyor from an upstream location to a downstream location. In certain conveyor systems, during operation, it may be desired to move one or more packages in a direction other than the flow direction, such as to various lateral positions or bins disposed laterally to the conveyor. For example, in some conveyor systems it may be desirable for a user to be able to push objects perpendicularly to the direction of the flow of a conveyor, such as to another conveyance lane, another conveyor, and/or accumulation devices disposed laterally to the conveyor.

In some conveyor systems, the conveying surface of one or more conveyors may be defined by a plurality of bi-directional wheels each mounted on an axle and supported by bearings mounted to the frame. For example, the wheels may be pivotable, selectively driven, or otherwise complex to enable bi-directional movement of packages. However, use of such bi-directional wheels generally requires new conveyors and are not easily incorporated into preexisting conveyors. Additionally, upon failure of the rollers within the wheels, the entire wheel must be generally replaced as replacement rollers for the wheels are not generally available. Further, to operate, gaps or other spaces are required between the wheels such that packages being conveyed along the bi-directional wheels may catch and/or otherwise become stuck.

Therefore, it would be more desirable to provide a bi-directional roller that is more easily incorporated into existing conveyor systems and/or that reduces the likelihood of packages from catching and/or otherwise becoming stuck during conveyance.

### SUMMARY

The following is a brief summary of subject matter that is described in greater detail herein. This summary is not intended to be limiting as to the scope of the claims.

According to various embodiments, a roller for bi-directional conveyance in a conveyor system has an axis of rotation extending along a length of the roller. Further, the roller includes wheels disposed at positions along the length of the roller. Axes of rotation of the wheels of the roller are perpendicular to the axis of rotation of the roller. In various embodiments, adjacent wheels along the length of the roller can be circumferentially offset relative to each other.

According to various embodiments, a conveyor includes a first frame member, a second frame member, and a plurality of rollers disposed between the first frame member and the second frame member. The rollers define a conveying surface of the conveyor. It is contemplated that one or more of the rollers of the conveyor can be a roller for bi-directional conveyance that includes wheels as described herein.

In various embodiments, the wheels of the roller can be disposed partially within an outer surface of the roller and can extend partially beyond the outer surface of the roller such that the wheels at least partially define part of a conveying surface. Moreover, in various embodiments, the roller can include a plurality of wheels disposed circumferentially around the roller at one or more of the positions along the length of the roller.

Pursuant to various embodiments, the roller can include a first end connector having a plurality of wheel receiving cavities and a second end connector having a plurality of wheel receiving cavities. The roller can further include a plurality of medial connectors disposed between the first end connector and the second end connector along the length of the roller. Each medial connector can have a first connecting portion with a plurality of wheel receiving cavities, a second connecting portion with a plurality of wheel receiving cavities, and a medial portion disposed between the first connecting portion and the second connecting portion. Further, adjacent connectors can be connected along the length of the roller with adjacent wheel receiving cavities being aligned. Moreover, the wheels are disposed in the aligned pairs of wheel receiving cavities.

In accordance with other embodiments, the roller can include a plurality of cartridges each having a first coupling portion, a second coupling portion, and a housing portion that includes one or more of the wheels. The roller can further include a plurality of spacers. The spacers can couple one of the coupling portions of adjacent cartridges to each other.

This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is a perspective view of a conveyor for bi-directional movement;

FIG. 2 is a top view of the conveyor of FIG. 1;

FIG. 3 is a front view of the conveyor of FIG. 1;

FIGS. 4A-4C illustrate various views of a wheel for use with a roller of the conveyor of FIG. 1;

FIGS. 5A-5C illustrate various views of the wheel of FIGS. 4A-4C disposed on a wheel axle;

FIGS. 6A-6D illustrate various views of a roller according to one embodiment for use with the conveyor of FIG. 1;

FIG. 7A is a perspective view of a first end connector for use with the roller of FIGS. 6A-6D;

FIG. 7B is an enlarged view of a portion of the first end connector of FIG. 7A;

FIGS. 7C-7D illustrate various views of the first end connector of FIG. 7A;

FIGS. 8A-8C illustrate various views of a second end connector for use with the roller of FIGS. 6A-6D;

FIGS. 9A-9D illustrate various views of a medial connector for use with the roller of FIGS. 6A-6D;

FIG. 10 is a partial perspective view of the roller of FIGS. 6A-6D with the first end connector removed to show an inner tube;

FIG. 11 is a partial perspective view of the roller of FIGS. 6A-6D with the first end connector, a medial connector, and the inner tube removed to show a biasing element;

FIG. 12 is a perspective view of a roller according to another embodiment for use with the conveyor of FIG. 1;

FIG. 13 is a perspective view of the roller of FIG. 12 with components removed to show the axle and inner tube of the roller;

FIGS. 14A-14D show various views of a cartridge for use with the roller of FIG. 12;

FIGS. 15A-15D show various views of two cartridge halves which form the cartridge of FIGS. 14A-14D;

FIG. 16 is a cross sectional view of the cartridge of FIGS. 14A-14D;

FIGS. 17A-17B show various views of a spacer for use with the roller of FIG. 12; and

FIGS. 18A-19C show various connections of the cartridges of FIGS. 14A-14D and the spacers of FIGS. 17A-17B.

### DETAILED DESCRIPTION

The following description refers to the accompanying drawings, which illustrate specific embodiments of the present disclosure. Other embodiments having different structures and operation do not depart from the scope of the present disclosure. The description and drawings are not intended to limit the scope of the invention in any manner.

“A” and “an” as used herein indicate “at least one” of the item is present; a plurality of such items may be present, when possible. As used herein, “substantially” means “to a considerable degree,” “largely,” or “proximately” as a person skilled in the art in view of the instant disclosure would understand the term. Spatially relative terms, such as “front,” “back,” “inner,” “outer,” “bottom,” “top,” “horizontal,” “vertical,” “upper,” “lower,” “side,” “up,” “down,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Described herein are various technologies pertaining to a roller for bi-directional conveyance of one or more packages, and conveyors incorporating the same. It will be understood that the term “packages” is not limited to boxes containing items, but also encompasses any items or articles which may be conveyed along a conveyor. The roller includes a plurality of sub-rollers or wheels disposed along a length of the roller and oriented in a substantially different direction than the roller. The sub-rollers or wheels may be embedded or otherwise disposed within an outer surface of the rollers. The sub-rollers or wheels are configured to rotate about axes extending in a direction non-parallel to the rotational axis of the roller, such as axes substantially perpendicular to the axis of the roller. Each bi-directional roller may comprise one or more components which may be combined such that the bi-directional roller may be implemented as part of a pre-existing conveyor. For example, one or more components of the roller may be retrofitted upon the axle of a pre-existing roller used in a pre-existing conveyor such that the bi-directional roller may be implemented as part of the pre-existing conveyor. The wheels may be positioned to extend radially beyond the remainder of the outer surface of the roller such that packages disposed on the roller are disposed on at least one wheel. The wheels may extend to a height radially beyond the remainder of the roller and/or wheels of each roller may be positioned longitudinally (e.g., along the length of the roller) relative to adjacent rollers to minimize spacing between adjacent rollers, such as to reduce the likelihood of packages catching or otherwise becoming stuck between rollers.

Further, the bi-directional rollers described herein are modular in that a plurality of components may be assembled together to form said rollers. Accordingly, the teachings disclosed herein may be applied to retrofit pre-existing rollers of various sizes and configurations in pre-existing conveyor systems without needing to replace the conveyor system. Additionally, in the event of failure of one or more components, such as due to normal wear, the roller may be removed from the conveyor and disassembled, the component may be replaced, and the roller may be placed back in the conveyor without needing to replace the entire roller.

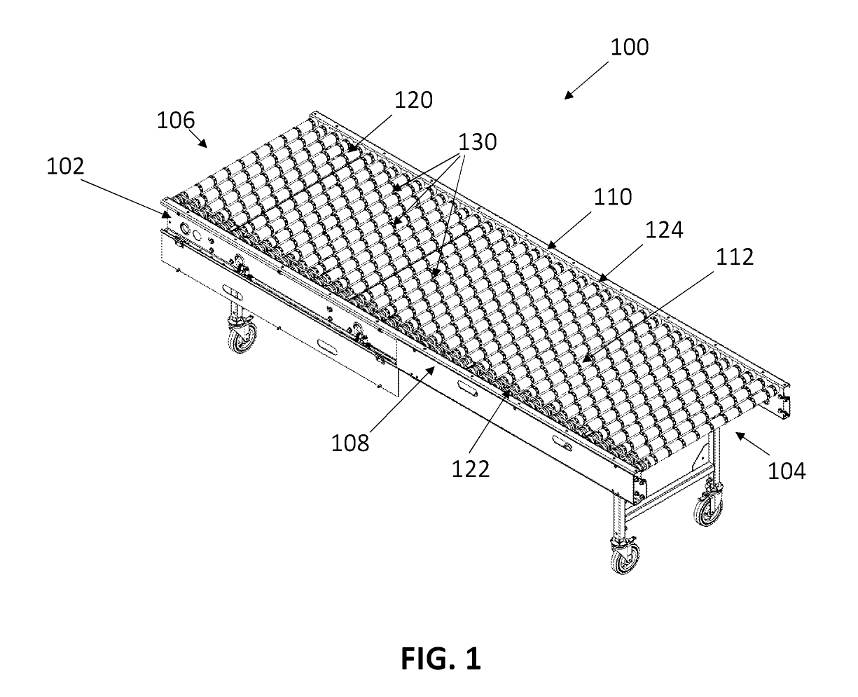

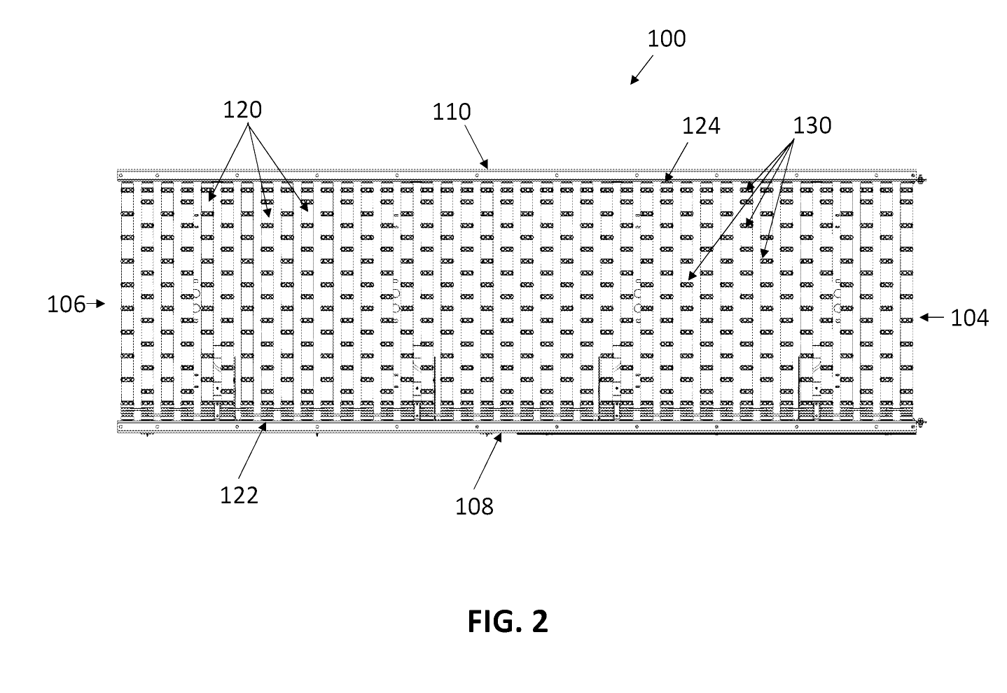

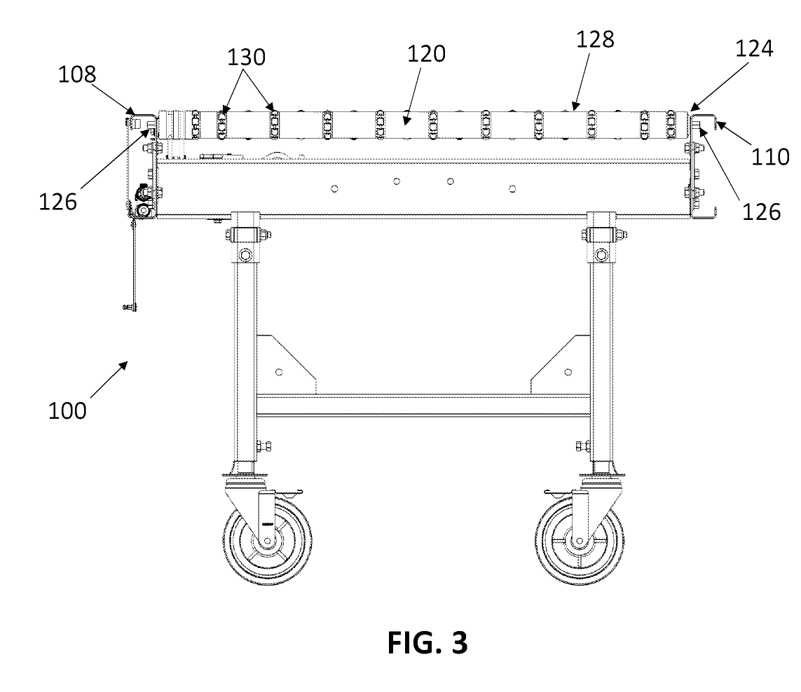

Referring to FIGS. 1-3, a conveyor 100 is depicted according to one embodiment. The conveyor 100 is configured for bi-directional conveyance of packages. It will be understood that the term “bi-directional conveyance” encompasses the conveyance or movement of packages in two or more directions along the conveyor. For example, packages may be conveyed or otherwise moved along the conveyance direction (e.g., upstream to downstream), in a direction orthogonal to the conveyance direction (e.g., laterally or side to side), and/or in a direction between the conveyance direction and the orthogonal direction (e.g., diagonally). In some embodiments, the conveyor 100 is configured such that the conveyor 100 conveys (e.g., moves) packages disposed on a conveying surface along the conveyance direction and facilitate or otherwise allows the orthogonal movement of packages on the conveying surface, such as when the one or more packages are acted upon by an outside lateral force, such as a user.

The conveyor 100 includes a frame 102 extending from an upstream end 104 to a downstream end 106 opposite the upstream end 104. The frame 102 includes a first frame member 108 extending substantially from the upstream end 104 to the downstream end 106 on a first side of the frame 102 and a second frame member 110 extending substantially from the upstream end 104 to the downstream end 106 on a second side of the frame 102 opposite from the first side. In some embodiments, the first and second frame members 108, 110 are substantially parallel. In the illustrated embodiment, the conveyor 100 is linear. However, the conveyor 100 may have other suitable shapes or configurations. For example, the conveyor 100 may be rounded, curved, serpentine, or the like.

In some embodiments, the frame 102 includes legs disposed on the underside of the frame 102 and wheels disposed at the ends of the legs such that the conveyor 100 may be moved or otherwise positioned, such as on a floor. The frame 102 may include one or more wheels disposed on an underside of each of the first frame member 108 and the second frame member 110 such that the conveyor 100 may be evenly supported, such as when incorporated into a conveyor system. In the illustrated embodiment, the frame 102 includes two legs on the underside of each of the first and second frame members 108, 110. However, it will be understood that the frame 102 may include any number of legs and/or the legs may be in any suitable positions.

The conveyor 100 includes a plurality of rollers 120 extending between the first and second frame members 108, 110. Each roller 120 may be substantially cylindrical and extend from a first end 122 to a second end 124 opposite the first end 122. Each roller 120 may have a length extending between the first and second ends 122, 124 and the length of each roller 120 may be slightly greater than a distance between the first and second frame members 108, 110. The first end 122 of each roller 120 may be connected or otherwise attached to the first frame member 108 and the second end 124 of each roller 120 may be connected or otherwise attached to the second frame member 110. Each roller 120 may be configured to rotate about an axis extending longitudinally through the roller 120 and between the first and second frame members 108, 110 such that a package disposed on one or more rollers 120 may be conveyed in a direction extending between the upstream end 104 and the downstream end 106 (e.g., the conveyance direction).

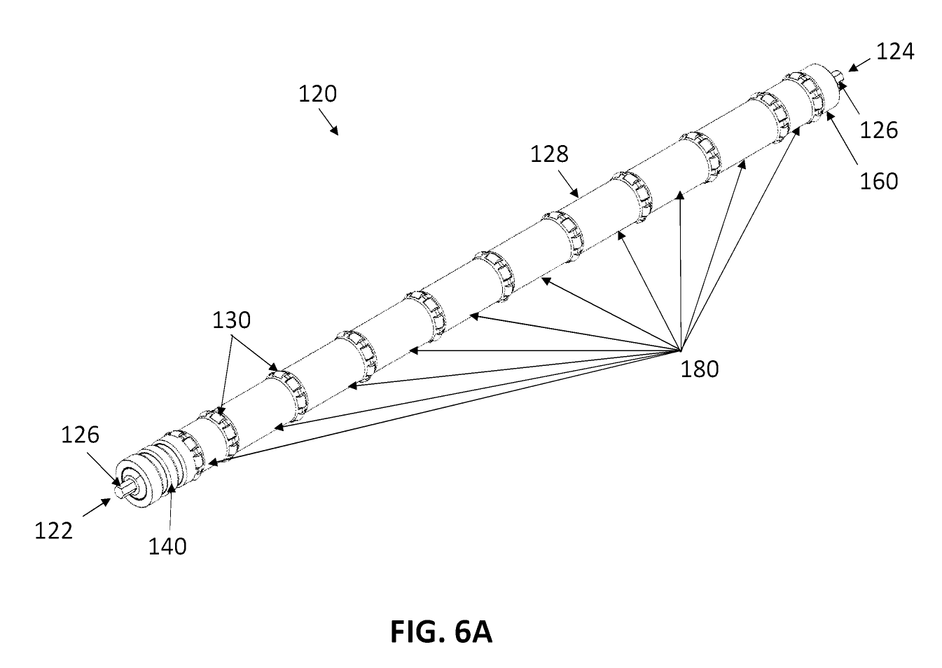

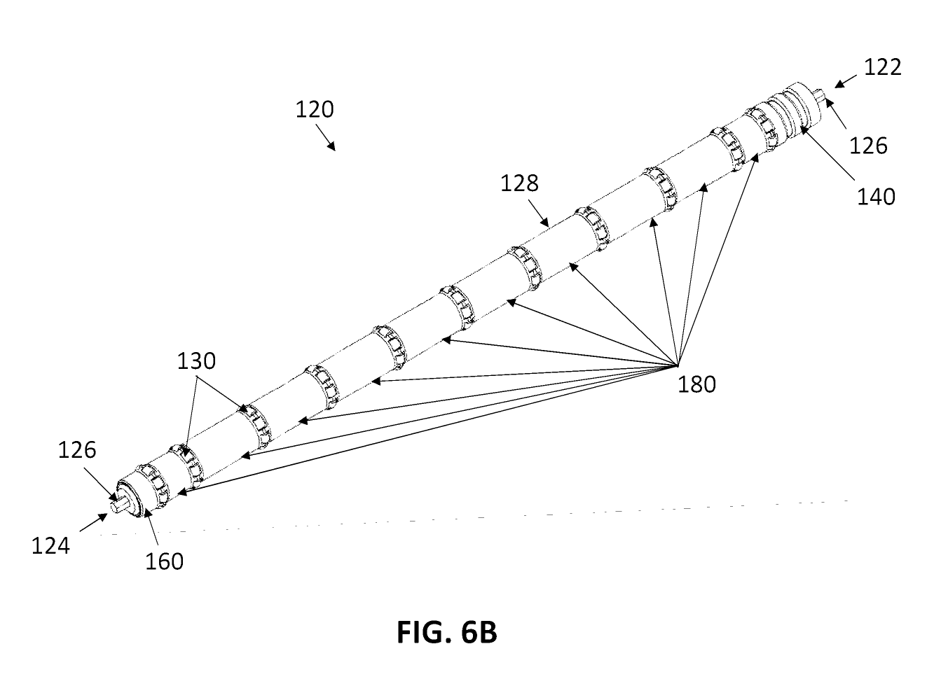

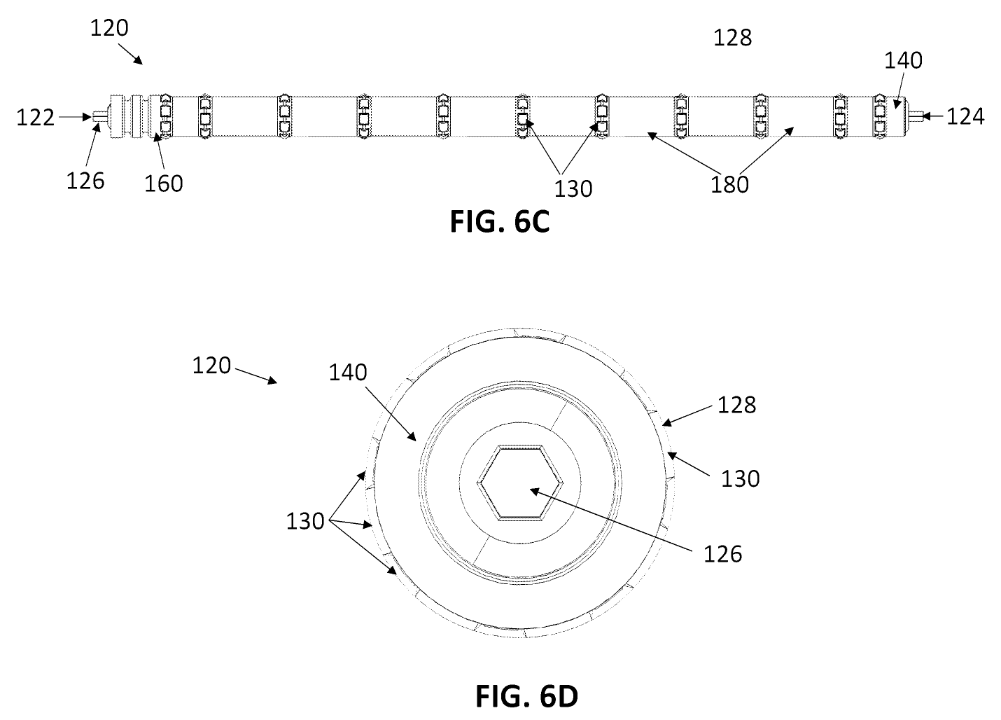

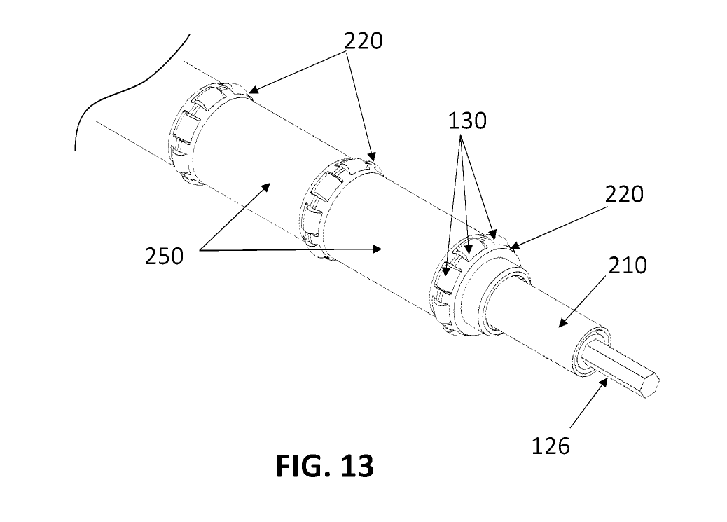

Each roller 120 may include an axle 126 (see FIGS. 6A-6D, 12-13) extending substantially through a center of the roller 120 from the first end 122 to the second end 124. In some embodiments, each roller 120 is configured such that the axle 126 may be rotationally fixed relative to the first and second frame members 108, 110 and such that the remainder of the roller 120 may rotate about the axle 126, as detailed below. The axle 126 may be sized, shaped, and configured to attach or otherwise couple the roller 120 with the first and second frame members 108, 110, respectively. For example, the axle 126 may have a size and shape corresponding to axle receiving apertures in the first and second frame members 108, 110 such that the axle 126 may be inserted through aligned axle receiving apertures in the first and second frame members 108, 110 and secured. The axle 126 may be further secured in the first and second frame members 108, 110 via fasteners, caps, or the like. In some embodiments, the axle 126 and axle receiving apertures of the first and second frame members 108, 110 are hexagonal, such as to maintain the rotational position of the axle 126 relative to the first and second frame members 108, 110. However, it will be understood that the axle 126 and the axle receiving apertures may have any suitable shape.

While the axle 126 has been described as being connected to the first and second frame members 108, 110 via insertion through axle receiving apertures in the first and second frame members 108, 110, it will be understood that the axle 126 may be connected to the frame members 108, 110 via any suitable method or manner and that different connections between the axle 126 and the frame members 108, 110 do not depart from the scope of this disclosure. For example, it will be understood that the bi-directional rollers 120 discussed in this application may be used in place of pre-existing rollers and may be retrofitted onto the axles of the pre-existing rollers, incorporating the previous manner of attaching the axle to the frame members.

While the conveyor 100 has been described as including first and second frame members 108, 110 and rollers 120 extending substantially between the first and second frame members 108, 110, it will be understood that the conveyor 100 may have other suitable configurations. For example, the conveyor 100 may include a third frame member disposed between the first and second frame members 108, 110 with a plurality of rollers 120 extending between the first frame member 108 and the third frame member and a plurality of rollers 120 extending between the third frame member and the second frame member 110, such as to have two separate lanes for conveying packages.

Each roller 120 is substantially cylindrical having an outer surface 128 extending radially outwardly from the axle 126. In some embodiments, the outer surface 128 is generally smooth such that packages may be conveyed along the conveyor 100. In some embodiments, except as otherwise described below, the outer surface 128 of the roller 120 is substantially arcuate and/or flat in the longitudinal direction and circular in the radial direction.

The rollers 120 are configured such that that the outer surface 128 of the roller 120 may rotate about the axle 126 of the roller 120 independently from the axle 126. For example, the axle 126 may remain stationary and the remainder of the roller 120 may rotate about the axle 126. In some embodiments, each roller 120 includes a plurality of bearings disposed between the axle 126 and the outer surface 128 such that the outer surface 128 may be rotated about the axle 126.

The conveyor 100 includes a conveying surface 112 extending from the upstream end 104 to the downstream end 106 and between the first and second frame members 108, 110. The conveyor 100 may be configured such that packages received at the upstream end 104, such as from an upstream conveyor, may be conveyed to the downstream end 106, such as to a downstream conveyor. The rollers 120 may be positioned and/or otherwise configured such that the top portions of the rollers 120 define the conveying surface 112. It will be understood that the rollers 120 are substantially cylindrical, define an outer surface or circumference, and are configured to rotate such that the conveying surface 112 is defined by the top (upwardly facing) portions of the outer surfaces 128 of each roller 120 at any given time. In some embodiments, the rollers 120 may be positioned in close proximity to adjacent rollers 120 (e.g., along a conveying direction) such that the conveying surface 112 is substantially continuous and/or such that packages do not fall or otherwise get caught between adjacent rollers 120.

In some embodiments, one or more of the rollers 120 may be driven such that the rollers 120 rotate about their respective axle 126 to such that packages disposed on the conveying surface 112 are conveyed in the conveying direction (e.g., in the direction of rotation of the rollers 120). For example, one or more rollers 120 may be rotationally coupled with one or more drive motors and/or drive shafts via one or more drive belts such that the rollers 120 rotate with the drive motor and/or drive shaft. The remainder of the rollers 120 may be connected to adjacent rollers 120 via one or more connecting belts such that the rotation of the roller 120 driven by the drive motor and/or drive shaft may be transferred to the subsequent rollers 120.

In the illustrated embodiment, each roller 120 includes a drive connector or bearing disposed near the first end 122 of the roller 120 and configured to permit the roller 120 to be driven. The bearing may include two channels configured for receiving one or more belts for driving the rotation of the roller 120. For example, a drive belt coupled with the drive motor and/or drive pully may be received in the first channel and a connecting belt may be received in the second channel and also received in the second channel of an adjacent roller 120 such that the belts cause the rollers 120 to rotate with the drive motor and/or the drive shaft. However, it will be understood that the rollers 120 by any suitable manner and/or connection.

Alternatively, it will be understood that the rollers 120 may not be driven. For example, the conveying surface 112 at the upstream end 104 of the frame 102 may be disposed at a higher position of the conveying surface 112 at the downstream end 106 of the frame 102 such that packages may be conveyed from the upstream end 104 to the downstream end 106 via gravity.

Each roller 120 may also include a plurality of sub-rollers or wheels 130 configured to permit conveyance of packages in a direction other than the conveying direction of the conveyor 100 (e.g., the rotational direction of the rollers 120). Each of the wheels 130 is oriented at a direction different from the axial direction of the rollers 120. In some embodiments, each of the wheels 130 is oriented in substantially the same direction. In some embodiments, each of the wheels 130 is oriented substantially perpendicularly to the central longitudinal axis of the respective roller 120. However, it will be understood that the wheels 130 may be disposed at any suitable orientation and/or the wheels 130 may be disposed at differing orientations.

In the illustrated embodiment, the wheels 130 are disposed substantially parallel to the remainder of the roller 120 (e.g., the axle 126) and the first and second frame members 108, 110. However, it will be understood that the wheels 130 may be disposed at any suitable orientation relative to the remainder of the roller 120 (e.g., the axle 126) and/or the first and second frame members 108, 110.

Each wheel 130 is disposed at least partially within the roller 120 and is positioned and configured to extend partially radially beyond the remainder of the outer surface 128 of the roller 120 such that a portion of each wheel 130 forms the outer surface 128 of the roller 120. Each wheel 130 may be connected to the remainder of the roller 120 via an axis of rotation. In some embodiments, the axis of rotation of each wheel 130 is disposed radially inwardly from the remainder of the outer surface 128 of the roller 120 such that less than half of the wheel 130 extends radially beyond the remainder of the outer surface 128. The wheels 130 may be positioned around and/or along the rollers 120 such that packages conveyed along the conveyor 100 may be disposed along one or more wheels 130, as described below.

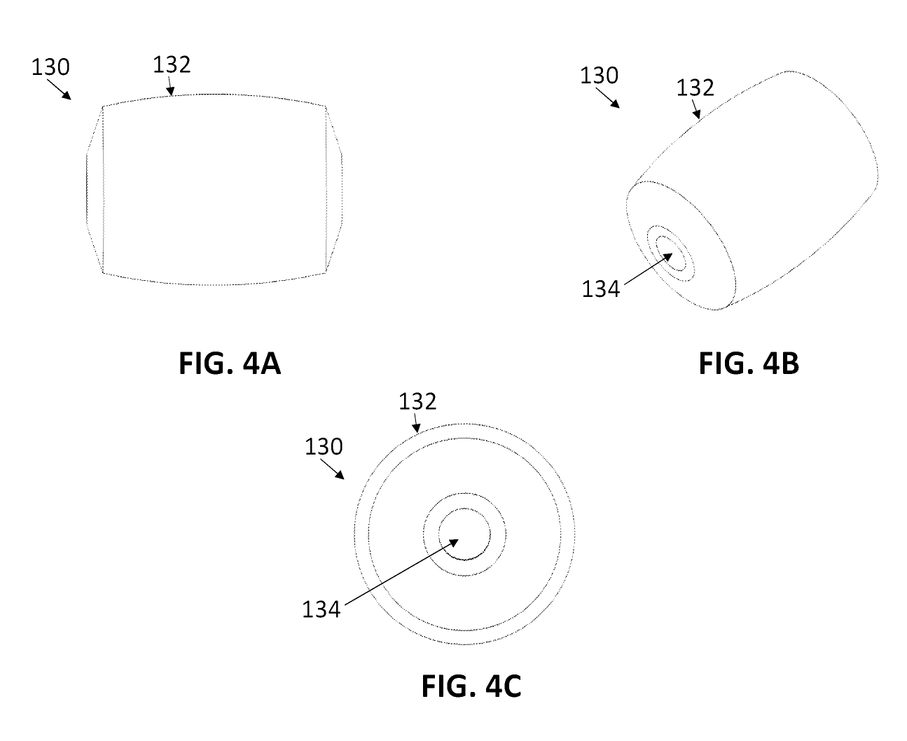

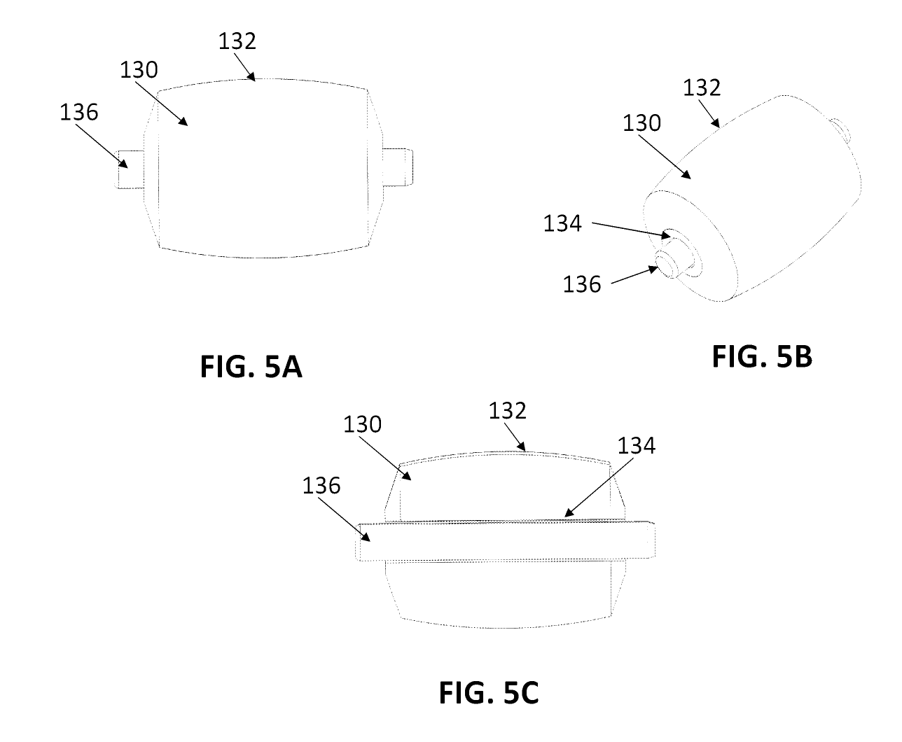

As shown in FIGS. 4A-5C, each wheel 130 is configured to rotate about an axis different from the axis of the roller 120 such that packages may be moved on the conveying surface 112 in a direction other than the conveying direction. Each wheel 130 has an outer wheel surface 132 extending radially outwardly from a center longitudinal axis. The wheel 130 has a diameter at at least one location along the length of the center longitudinal axis such that, when the wheel 130 is coupled with the roller 120, at least a portion of the outer wheel surface 132 extends radially outward beyond the remainder of the outer surface 128 of the roller 120, such as detailed below. In some embodiments, the outer wheel surface 132 of the wheel 130 is substantially smooth such that packages on the conveying surface 112 may be conveyed in the conveying direction and/or the rotational direction of the wheel 130 without catching or otherwise becoming stuck. In still further embodiments, the wheel 130 includes a material and/or coating on the outer wheel surface 132 such that the packages may be conveyed smoothly in both the conveying direction and the rotational direction of the wheel 130.

In the illustrated embodiment, the wheels are substantially barrel-shaped. However, it will be understood that the wheels 130 may have any suitable shape, size, and/or configuration. For example, the wheels 130 may be substantially cylindrical or substantially spherical and each roller 120 may comprise any suitable number and/or combination of different wheels 130.

The wheels 130 are attached to the roller 120 such that the wheels 130 may each rotate about an axis different from the rotational axis of the roller 120 (e.g., the axle 126). Each wheel 130 includes a wheel axle passage 134 extending through a center of the wheel 130 along a longitudinal direction of the wheel 130. The wheel axle passage 134 may be a substantially cylindrical bore or passage. A wheel axle 136 extends through the wheel axle passage 134 of the wheel 130 such that the wheel 130 may rotate about wheel axle 136. For example, the wheel axle 136 may have a diameter slightly less than a diameter of the wheel axle passage 134. The wheel axle 136 has a length greater than a length of the wheel axle passage 134 of the wheel 130 such that the wheel axle 136 may be coupled with the roller 120 and the wheel 130 may rotate about the wheel axle 136, such as detailed below. In some embodiments, the wheel axle 136 is connected or otherwise coupled with the remainder of the roller 120 such that the wheel axle 136 is disposed radially inwardly from the remainder of the outer surface 128 of the roller 120.

In the illustrated embodiment, a single wheel axle 136 extends through a single wheel axle passage 134 to couple each wheel 130 to the remainder of the roller 120. However, it will be understood that the wheels 130 may be coupled with the remainder of the roller 120 in other suitable manners. For example, the wheels 130 may each include two wheel axle bores extending partially into the wheel 130 from either side of the wheel 130 and wheel axles may extend into the axle bores from the roller 120 to maintain the position the wheels 130 in a pinching manner.

Referring back to FIGS. 1-3, the wheels 130 may be disposed around the rollers 120 such that rotation of the rollers 120 about the axles 126 may convey packages along the conveying direction of the conveyor 100 and rotation of the wheels 130 about the wheel axles 136 may allow packages to be maneuvered in a direction other than the conveying direction along the conveying surface 112. In some embodiments, the wheels 130 are disposed generally around a circumference of the outer surface 128 of the roller 120 such that one or more wheels 130 permit packages may be maneuvered along one or more wheels 130 regardless of the rotational position of the roller 120 about the axle 126. For example, the wheels 130 may be disposed circumferentially around the roller 120 such that one or more wheels 130 define a portion of the conveying surface 112 (e.g., the top portion of the outer surface 128 of the roller 120) regardless of the rotational positions of the rollers 120 about the axles 126.

Each roller 120 may include a plurality of wheels 130 disposed at different positions longitudinally along the length of the roller 120. The wheels 130 may be spaced apart along the length of the roller 120 and the outer surface 128 of the roller 120 is substantially solid between adjacent wheels 130. In some embodiments, each roller 120 includes circumferential bands of wheels 130 disposed around the outer circumference of the roller 120 and spaced apart from other bands of wheels 130 along the length of the roller 120. In some embodiments, the wheels 130 of each roller 120 (e.g., the bands of wheels 130) are spaced apart along the length of the respective roller 120 such that the wheels 130 of a first roller 120 are offset from the wheels 130 of an adjacent, second roller 120.

Each roller 120 may include any suitable number of wheels 130 in each band of wheels 130 such that the bands of wheels 130 extend substantially around the outer circumference of the roller 120. It will be understood that the number of wheels 130 may be dependent upon a variety of factors such as the diameters of the wheels 130, the lengths of the wheels 130, and the diameter of the roller 120.

In some embodiments, the wheels 130 of each roller 120 may be disposed at staggered and/or different positions circumferentially around the outer surface 128 of the roller 120 along the length of the roller 120. For example, the wheels 130 of each roller 120 may be disposed at different positions circumferentially around the outer surface 128 along the length of the roller 120 so that one or more wheels 130 define the outer surface 128 of the roller 120 (e.g., disposed at the top of the roller 120) for all rotational positions of the roller 120 about the axle 126.

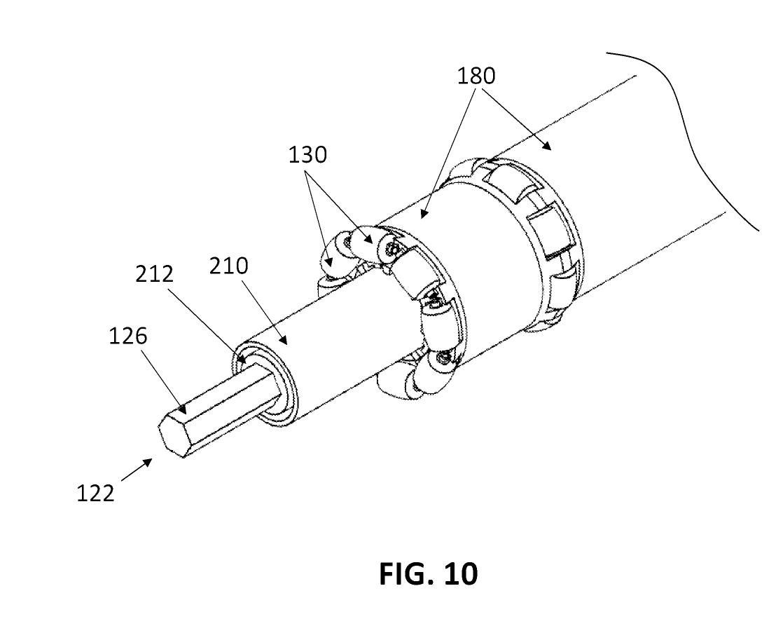

Referring now to FIGS. 6A-11, the bi-directional roller 120 is shown according to one embodiment. A plurality of the rollers 120 may be implemented into a conveyor, such as the conveyor of FIGS. 1-3, or one or more of the rollers 120 may be retrofit into a known or pre-existing conveyor, such as by modifying the rollers of the pre-existing conveyor.

The bi-direction roller 120 includes a first end connector 140, a second end connector 160, and a plurality of medial connectors 180 disposed longitudinally between the first and second end connectors 140, 160. Each connector 140, 160, 180 is coupled to the adjacent connector(s) 140, 160, 180 such that the connectors 140, 160, 180 are connected in series along the length of the roller 120. A plurality of wheels 130 are disposed between each connected pair of connectors 140, 160, 180, as described below.

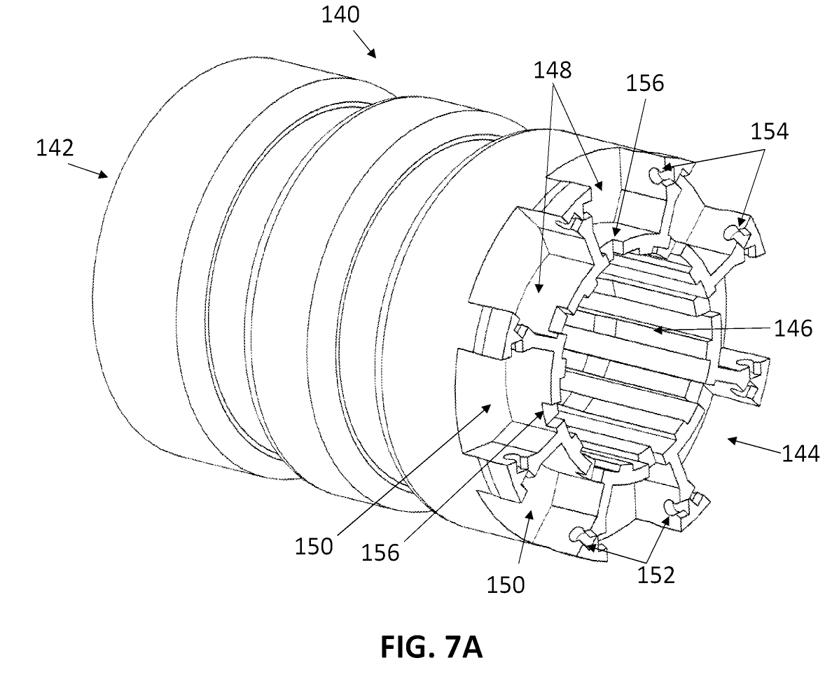

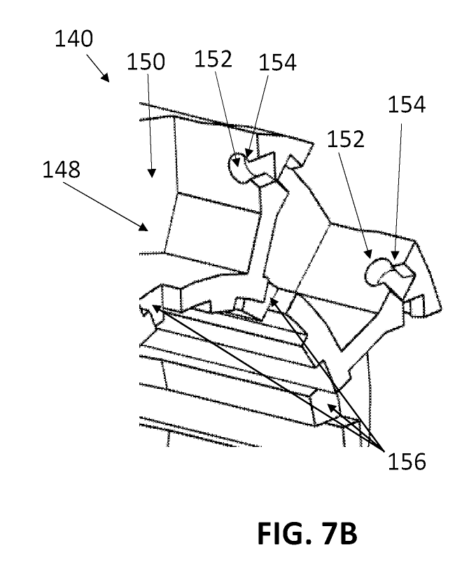

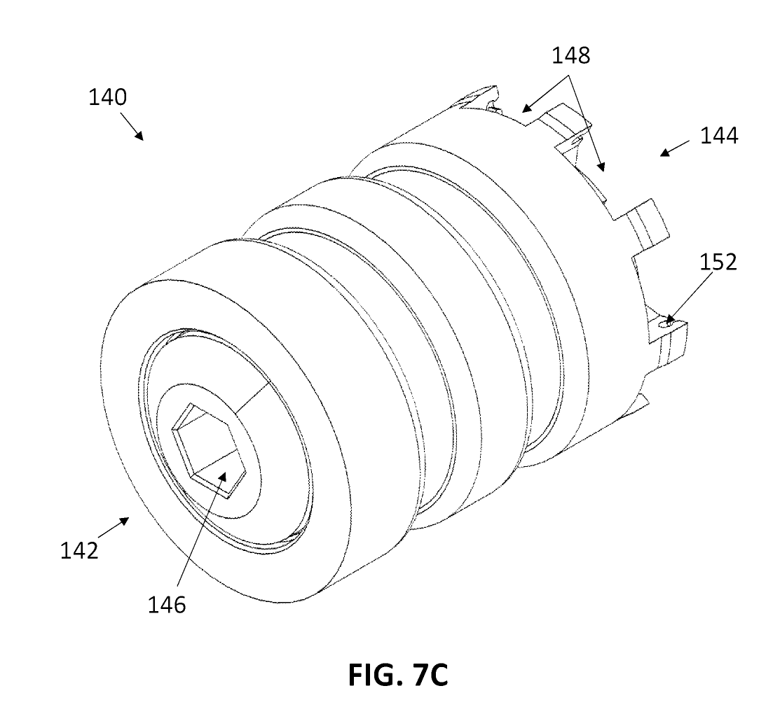

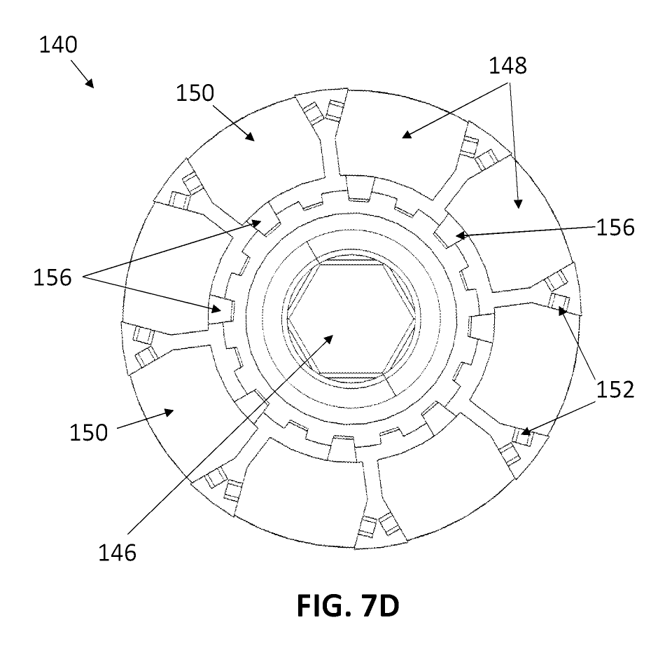

As shown in FIGS. 6A-7D, the first end connector 140 is disposed near the first end 122 of the roller 120, the second end connector 160 disposed near the second end 124 of the roller 120, and the plurality of medial connectors 180 disposed between the first and second end connectors 140, 160. The connectors 140, 160, 180 are configured to be assembled together over the axle 126 and to receive wheels 130 and wheel axles 136 between adjacent connectors 140, 160, 180 such that the connectors 140, 160, 180 and wheels 130 define the outer surface 128 of the roller 120. The connectors 140, 160, 180 also configured such that packages disposed on the conveying surface 112 may be conveyed or otherwise maneuvered in the conveying direction and a direction other than the conveying direction, such as a direction substantially perpendicular to the conveying direction.

The first end connector 140 is configured to be disposed around the axle 126 near the first end 122 and to at least partially couple with a plurality of the wheels 130. The first end connector 140 may also be configured to operate as or otherwise define the portion of the conveying surface 112 nearest the first frame member 108.

The first end connector 140 is substantially cylindrical with a first end 142 and a second end 144 opposite the first end 142. The first end connector 140 also includes an axle receiving passage 146 extending longitudinally through a center of the first end connector 140. The axle receiving passage 146 is sized, shaped, and configured to receive the axle 126 therein and/or therethrough. In the illustrated embodiment, the axle receiving passage 146 extends through the first end connector 140 from the first end 142 to the second end 144. However, it will be understood that the first end connector 140 may have other suitable configurations. For example, the axle receiving passage 146 may extend only partially into the first end connector 140 from the second end 144, such as in embodiments where the first end connector 140 is operates as an end cap for the roller 120.

The first end connector 140 has a plurality of wheel receiving cavities 148 extending inwardly from the second end 144. Each wheel receiving cavity is configured to at least partially receive one wheel 130 and the corresponding wheel axle 136 therein. The wheel receiving cavities 148 are disposed circumferentially around the perimeter of the second end 144 and extend radially inwardly from the outer surface of the first end connector 140.

In the illustrated embodiment, the first end connector 140 includes eight wheel receiving cavities 148. However, it will be understood that the first end connector 140 may have other configurations. For example, the first end connector 140 may include fewer than eight wheel receiving cavities 148 or more than eight wheel receiving cavities 148.

Each wheel receiving cavity 148 includes a wheel receiving portion 150 and axle receiving portions 152 on either side (e.g., circumferentially) of the wheel receiving portion 150. Each wheel receiving portion 150 is configured to partially receive one of the wheels 130 and the axle receiving portions 152 are configured to partially receive the wheel axle 136 of the wheel 130 disposed partially within the wheel receiving cavity 148. The wheel receiving portion 150 is in communication with the two corresponding axle receiving portions 152 such that the wheel 130 and the wheel axle 136 may be received in the wheel receiving cavity 148 when the wheel axle 136 is inserted through the wheel axle passage 134 of the wheel 130.

Each wheel receiving portion 150 is sized, shaped, and configured to at least partially receive one of the wheels 130 therein such that a portion of the wheel 130 may extend radially out of the wheel receiving portion 150 (e.g., beyond the remainder of the first end connector 140) and such that the wheel 130 may rotate when the wheel 130 is at least partially disposed in the wheel receiving portion 150. The wheel receiving portion 150 may have a size and shape slightly larger than the portion of the wheel 130 to be received therein such that the wheel 130 may rotate substantially freely about the wheel axle 136 in the wheel receiving portion 150 without contacting the first end connector 140 (e.g., the walls of the wheel receiving portion 150).

In some embodiments, each wheel receiving portion 150 is configured to receive about half of one of the wheels 130 lengthwise. Each wheel receiving portion 150 may have a length about the same as or slightly larger than the longitudinal length of the respective wheel 130 and may have a depth extending into second end 144 of the first end connector 140 about the same distance as or slightly larger than a radius of the respective wheel 130. In some embodiments, the wheel receiving portion 150 may have a shape substantially corresponding to the shape of the wheel 130. For example, the wheel receiving portion 150 may be rounded and have a curvature corresponding to the shape of the portion of the wheel 130 disposed therein. However, it will be understood that the wheel receiving portions 150 may have any suitable shapes.

The axle receiving portions 152 may be disposed slightly radially inset from the radial outer surface of the first end connector 140 such that the wheels 130 may extend radially outward from the wheel receiving cavities 148 when the wheels 130 are coupled with the wheel axles 136 disposed at least partially within the axle receiving portions 152, such as described below.

In the illustrated embodiment, the axle receiving portions 152 are semi-circular or rounded grooves extending into the second end 144. However, it will be understood that the axle receiving portions 152 may have any suitable size, shape, and configuration. For example, the axle receiving portions 152 may be rectangular grooves extending into the second end 144 of the first end connector 140.

The wheel receiving cavities 148 may each be sized, shaped, and configured to maintain the respective wheel 130 in an operative position during operation of the roller 120. For example, the wheel receiving portions 150 may be sized, shaped, and configured such that each wheel 130 remains within the respective wheel receiving portion 150 and the wheel axle 136 remains at least partially within each of the respective pair of axle receiving portions 152. Each wheel receiving cavity 148 may have a width (e.g., combined width of the wheel receiving portion 150 and the axle receiving portions 152) which substantially retains the wheel 130 and wheel axle 136 within the wheel receiving cavity 148. In some embodiments, each wheel axle 136 has a length along a longitudinal axis of the wheel axle 136 that is greater than a combined width of the wheel receiving portion 150 and one of the axle receiving portions 152 such that lateral movement of the wheel axle 136 within the wheel receiving cavity 148 does not cause the wheel 130 and wheel axle 136 to fall out of the wheel receiving cavity 148. In still further embodiments, the wheel receiving cavity 148 has a width substantially the same as or slightly larger than the length of the respective wheel axle 136.

Each axle receiving portion 152 may be sized, shaped, and configured to at least partially maintain the wheel axle 136 within the axle receiving portion 152. Each axle receiving portion 152 may be sized, shaped, or configured such that the wheel axle 136 may be inserted into the axle receiving portions 152 and prevented or otherwise restricted from being removed from the axle receiving portions 152 when the first end connector 140 is connected to another connector, as described below. The wheel axles 136 may be held in position substantially by the axle receiving portions 152 of the first end connector 140 and/or may be held in position by the coupling of the first end connector 140 with another connector 160, 180.

In some embodiments, as shown in FIG. 7B, the first end connector 140 is configured such that one or more axle receiving portions 152 include a neck portion 154 near the opening of the axle receiving portion 152 (e.g., near the second end 144) configured to at least partially retain the wheel axle 136 within the axle receiving portion 152. The neck portion 154 narrows the opening into the axle receiving portion 152 (e.g., extends circumferentially) from the second end 144 such that the wheel axle 136 may be received in the axle receiving portion 152 and such that the neck portion 154 may substantially prevent the wheel axle 136 from being removed from the axle receiving portion 152.

In some embodiments, the neck portion 154 of each axle receiving portion 152 is sized, shaped, and configured such that the respective wheel axle 136 may be press fit or snap fit into the axle receiving portions 152. For example, the neck portion 154 may define an opening having a size large enough to permit the wheel axle 136 to be inserted into the axle receiving portion 152 and the opening may also be small enough to substantially prevent the wheel axle 136 from being retracted from the axle receiving portion 152, such as during normal operation of the roller 120.

While each of the axle receiving portions 152 have been described as having neck portions 154, it will be understood that the first end connector 140 may have other suitable configurations. For example, only some of the axle receiving portions 152 may have neck portions 154, such as half of the axle receiving portions 152 (e.g., axle receiving portions 152 of every other wheel receiving cavity 148) having neck portions 154 such that the other wheel axles 136 are retained by the neck portions of other connectors, as described below. Additionally or alternatively, the first end connector 140 may not have neck portions 154 and the wheel axle 136 may be retained in the axle receiving portions 152 of adjoining connectors when the connectors are coupled together, as described below.

The first end connector 140 may also include one or more components configured to couple the first end connector 140 to an adjacent connector 160, 180. As shown in FIGS. 7A-7D, the first end connector 140 may also include one or more longitudinal receiving portions 156 configured to facilitate the operative coupling of the first end connector 140 to another connector 160, 180, as described below. The longitudinal receiving portions 156 extend longitudinally inwardly from the second end 144. Each longitudinal receiving portions 156 is sized, shaped, and configured to receive a longitudinally extending projection of a connector 160, 180 to be coupled with the first end connector 140. The longitudinally extending projections may extend longitudinally from an end of an adjacent connector 160, 180 and toward the first end connector 140 such that the longitudinally extending projections may be received in the longitudinal receiving portions 156 to partially couple the other connector 160, 180 with the first end connector 140, such as to secure the wheels 130 and wheel axles 136 therebetween.

The longitudinal receiving portions 156 may be positioned circumferentially around the first end connector 140 such that the first end connector 140 is substantially aligned with the adjacent connector 160, 180 when the longitudinally extending portions of the adjacent connector 160, 180 are received in the longitudinal receiving portions 156 of the first end connector 140. For example, the longitudinal receiving portions 156 may be positioned such that the wheel receiving cavities 148 of the first end connector 140 are substantially aligned with the wheel receiving cavities of the adjacent connector 160, 180 when the adjacent connector 160, 180 is coupled with the first end connector 140. In still further embodiments, the longitudinal receiving portions 156 are positioned such that wheels 130 on an opposite end of an adjacent connector 160, 180 (e.g., on the side opposite the first end connector 140) are disposed at different circumferential positions from the wheels 130 connected to the first end connector 140, as detailed below.

In some embodiments, one or more longitudinal receiving portions 156 are configured to receive the respective longitudinally extending projection and to substantially interlock and/or prevent the longitudinally extending projection from retracting therefrom. For example, the longitudinal receiving portions 156 may include a neck portion which prevents the respective longitudinally extending projection from retracting from the longitudinal receiving portion 156. Additionally or alternatively, the longitudinal receiving portions 156 may be shaped such that the longitudinally extending projections may be transversely slotted into the longitudinal receiving portions 156 and substantially prevented from being longitudinally retracted therefrom. In some embodiments, the longitudinal receiving portions 156 are configured to couple with the respective longitudinally extending projections via a snap fit or interference fit.

Additionally or alternatively, the first end connector 140 may include one or more longitudinally projecting portions configured to be received in longitudinal receiving portions of an adjacent connector 160, 180 to maintain the coupling of the first end connector 140 with an adjacent connector 160, 180.

In the illustrated embodiment, the longitudinal receiving portions 156 are disposed near the axle receiving passage 146 and at the bottom (e.g., radially inward portion) of the wheel receiving portions 150 of the wheel receiving cavities 148. However, it will be understood that the first end connector 140 may have any suitable configuration. For example, the longitudinal receiving portions 156 may be at any suitable position near the second end 144 and the first end connector 140 may have a different number of longitudinal receiving portions 156 than wheel receiving cavities 148, such as a number and configuration of longitudinal receiving portions 156 corresponding to the number and configuration longitudinally extending projectors of a connector 160, 180 operatively coupled with the first end connector 140.

As shown in FIGS. 7A and 7C, in some embodiments, the first end connector 140 may include one or more channels disposed between the wheel receiving cavities 148 and the first end 142. Each of the channels may receive one or more drive belts and/or connecting belts such that the roller 120 may be driven and/or to transfer rotation to an adjacent roller 120. In some embodiments, the first end connector 140 includes two channels such that the roller 120 may be drive and such that the roller 120 may drive rotation of an adjacent roller 120. For example, one of the channels may receive a drive belt coupled with a drive motor and/or a drive shaft such that the first end connector 140 may rotate with the drive motor and/or the drive shaft. Additionally, the other channel may receive a connecting belt coupled with the channel of a first end connector 140 of an adjacent roller 120 such that rotation of the roller 120 may transfer to the adjacent roller 120. However, it will be understood that the first end connector 140 may have any suitable configuration.

In some embodiments, one or more of the rollers 120 may be driven such that the rollers 120 rotate about their respective axle 126 to such that packages disposed on the conveying surface 112 are conveyed in the conveying direction. For example, one or more rollers 120 may be rotationally coupled with one or more drive motors and/or drive shafts via one or more drive belts such that the rollers 120 rotate with the drive motor and/or drive shaft. The remainder of the rollers 120 may be connected to adjacent rollers 120 via one or more connecting belts such that the rotation of the roller 120 driven by the drive motor and/or drive shaft may be transferred to the subsequent rollers 120.

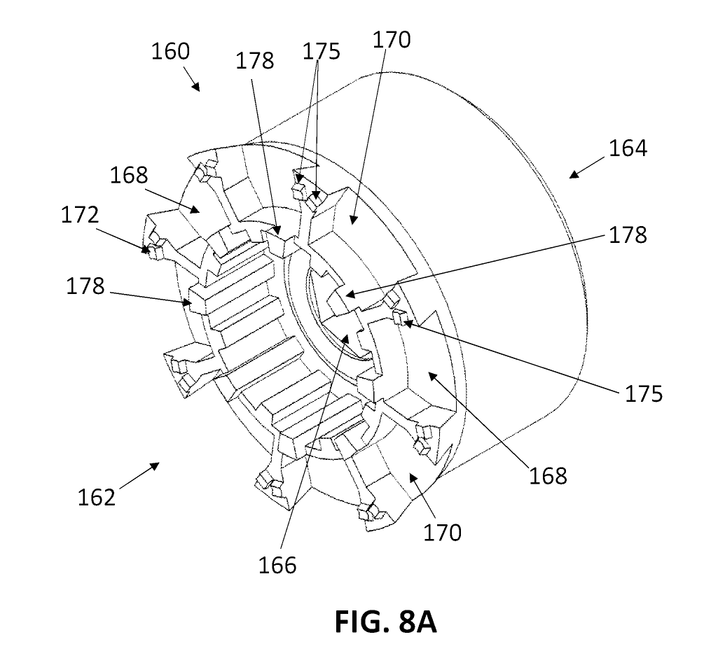

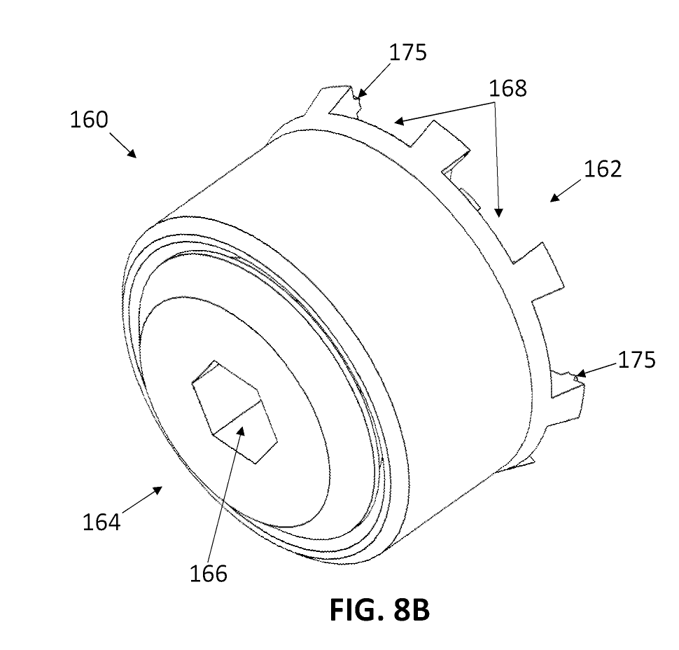

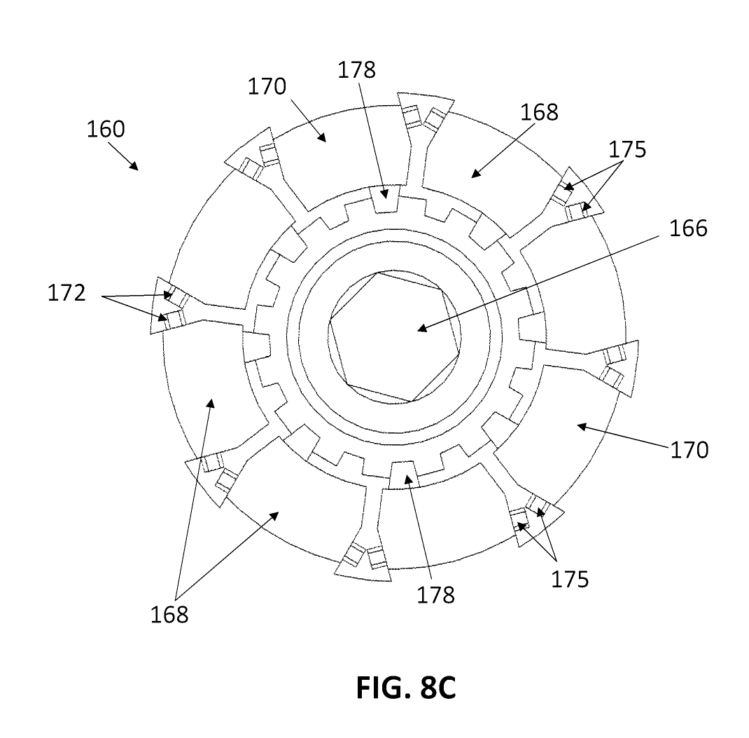

As shown in FIGS. 8A-8C, the second end connector 160 is configured to be disposed around the axle 126 near the second end 124 of the roller 120 and to at least partially couple with a plurality of the wheels 130. The second end connector 160 may also be configured to operate as or otherwise define the portion of the conveying surface 112 nearest the second frame member 110.

The second end connector 160 is substantially cylindrical with a first end 162 and a second end 164 opposite the first end 162. The second end connector 160 also includes an axle receiving passage 166 extending longitudinally through a center of the second end connector 160. The axle receiving passage 166 is sized, shaped, and configured to receive the axle 126 therein and/or therethrough. In some embodiments, the axle receiving passage 166 extends through the second end connector 160 from the first end 162 to the second end 164. However, it will be understood that the second end connector 160 may have other suitable configurations. For example, the axle receiving passage 166 may extend only partially into the second end connector 160 from the first end 162, such as in embodiments where the second end connector 160 operates as an end cap for the roller 120.

The second end connector 160 includes a plurality of wheel receiving cavities 168 extending longitudinally into the first end 162. The wheel receiving cavities 168 may be substantially similar to the wheel receiving cavities 148 of the first end connector 140 with each wheel receiving cavity 168 having a wheel receiving portion 170 and axle receiving portions 172 on either side of the wheel receiving portion 170.

In some embodiments, the wheel receiving cavities 168 of the second end connector 160 are substantially the same as the wheel receiving cavities 148 of the first end connector 140 (and of the medial connectors 180). For example, the axle receiving portions 152, 172 of the first and second end connectors 140, 160 (and the medial connectors 180) may be grooves or channels substantially corresponding to a lengthwise half of the wheel axles 136 such that two corresponding axle receiving portions 152, 172 substantially surround one of the wheel axles 136 when the connectors 140, 160, 180 are connected together.

In other embodiments, the wheel receiving cavities 168 of the second end connector 160 and/or the first end 162 of the second end connector 160 are configured to correspond to a side of the connector 140, 160, 180 to which the second end connector 160 is to couple. For example, in embodiments in which the wheel axles 136 are substantially retained in only one connector 140, 160, 180, such as within an axle receiving portion having a neck portion, the wheel receiving cavities 168 of the second end connector 160 and/or the first end 162 of the second end connector 160 may comprise a plurality of longitudinal projections 175 which may be partially received in the axle receiving portion of the corresponding connector 140, 180. The longitudinal projections 175 may substantially close the axle receiving portion of the other connector 140, 160 when the second end connector 160 is connected with the other connector 140, 160 such that the position of the wheel axle 136 may be substantially maintained during operation.

The second end connector 160 may also include one or more components configured to couple the second end connector 160 to an adjacent connector 140, 180. In some embodiments, the second end connector 160 includes one or more longitudinally extending projections 178 configured to facilitate the operative coupling of the second end connector 160 to another connector 140, 180. The longitudinally extending projections 178 extend longitudinally outward from the first end 162 of the second end connector 160. Each longitudinally extending projection 178 is sized, shaped, and configured to be received in a longitudinal receiving portion of a connector 140, 180 to be coupled with the second end connector 160. The longitudinally extending projections 178 may be received in the longitudinal receiving portions of the adjacent connector 140, 180 to at least partially couple the other connector 160, 180 with the second end connector 160, such as to secure the wheels 130 and wheel axles 136 therebetween.

The longitudinally extending projections 178 may be positioned circumferentially around the second end connector 160 such that the second end connector 160 is substantially aligned with the adjacent connector 140, 180 when the longitudinally extending projections 178 are received in the longitudinal receiving portions of the adjacent connector 140, 180. For example, the longitudinally extending projections 178 may be positioned such that the wheel receiving cavities 168 of the second end connector 140 are substantially aligned with the wheel receiving cavities of the adjacent connector 140, 180. In still further embodiments, the longitudinally extending projections 178 are positioned such that wheels 130 on an opposite end of an adjacent connector 140, 180 (e.g., on the side opposite the second end connector 160) are disposed at different circumferential positions from the wheels 130 connected to the second end connector 160, as detailed below.

In some embodiments, the longitudinally extending projections 178 are configured to be received in the longitudinal receiving portions of an adjacent connector 140, 180 and such that the longitudinally extending projections 178 are substantially prevented from retracting therefrom. For example, the longitudinally extending projections 178 may be sized, shaped, and configured to be received in longitudinal receiving portions similar to the longitudinal receiving portions 156 of the first end connector 140 described above. Accordingly, the longitudinally extending projections 178 may be disposed near the axle receiving passage 166 and at the bottom (e.g., radially inward portion) of the wheel receiving portions 170 of the wheel receiving cavities 168. However, it will be understood that the second end connector 160 may have any suitable configuration. For example, the longitudinally extending projections 178 may be at any suitable position near the first end 162 such that the second end connector 160 may have a different number of longitudinally extending projections 178 than wheel receiving cavities 168, such as a number and configuration of longitudinally extending projections 178 corresponding to the number and configuration of longitudinal receiving portions of a connector 140, 180 operative coupled with the second end connector 160.

Additionally or alternatively, the second end connector 160 may include one or more longitudinal receiving portions configured to receive the longitudinally extending projection(s) of an adjacent connector 140, 180 to maintain the coupling of the second end connector 160 with an adjacent connector 140, 180.

While the first end connector 140 has been described as having longitudinal receiving portions 156 and the second end connector 160 has been described as having longitudinally extending projections 178 for connecting to other connectors 140, 160, 180, it will be understood that the roller 120 may have other suitable configurations. For example, the first end connector 140 may have longitudinally extending projections and the second end connector 160 may have longitudinal receiving portions or the first and second end connectors 140, 160 may each having longitudinal receiving portions and longitudinally extending projections.

In the illustrated embodiment, the first end connector 140 has a different shape and configuration from the second end connector 160 as the first end connector 140 is also used for driving the roller 120. However, it will be understood that the first and second end connectors 140, 160 may have any suitable configurations. For example, the first and second end connectors 140, 160 may be substantial mirror images of each other, such as in conveyor embodiments incorporating another drive mechanism and/or when the rollers 120 are incorporated into gravity-fed conveyors.

In the illustrated embodiment, the axle receiving passages 146, 166 of the first and second end connectors 140,160 narrow near the outside end of the connector 140, 160 (e.g., the first end 142 of the first end connector 140 and the second end 164 of the second end connector 160) such that the axle receiving passages 146, 166 near the outside ends are substantially the same size as the axle 126. The variance in shape and/or size of the axle receiving passages 146, 166 may be configured such that the outside end of the connectors 140, 160 may operate as the ends of the rollers 120 and/or such that the inside ends of the axle receiving passages 144, 146 (e.g., the second end 144 of the first end connector 140 and the first end 162 of the second end connector 160) may receive an inner tube, as detailed below. However, it will be understood that the axle receiving passages 146, 166 of the first and second end connectors 140, 160 may have any suitable size, shape, and configure.

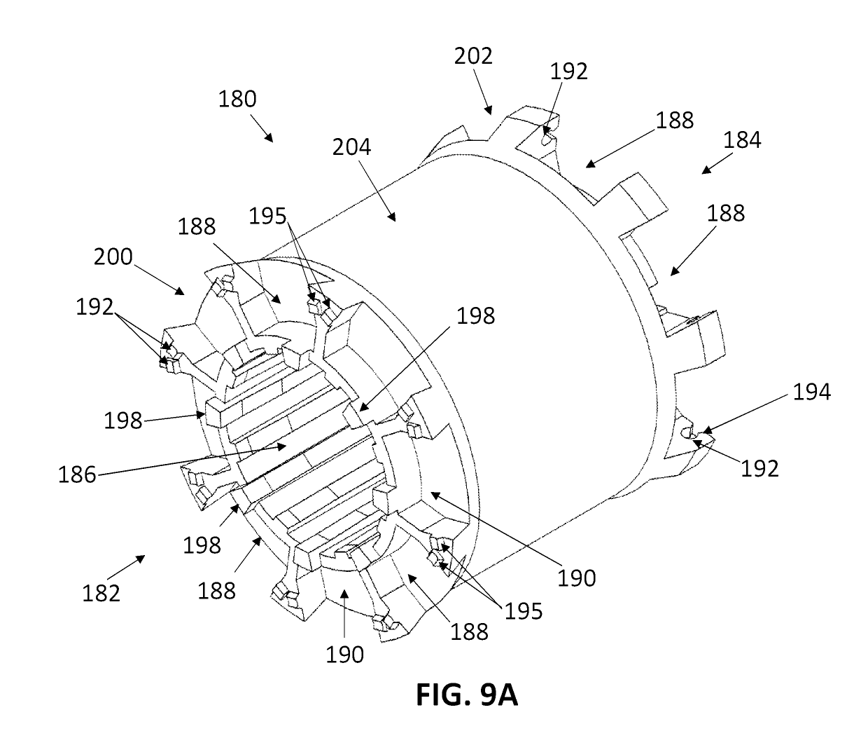

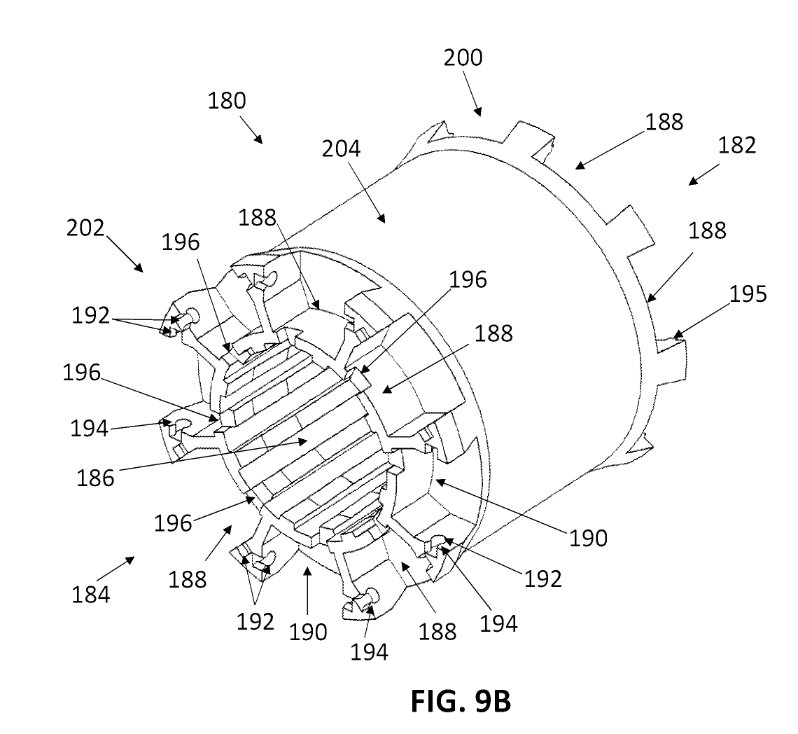

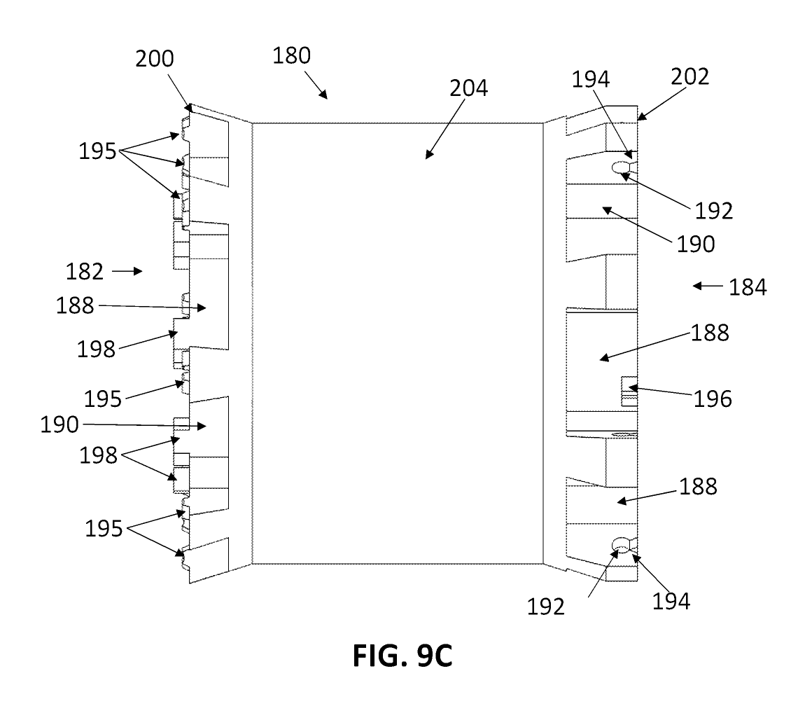

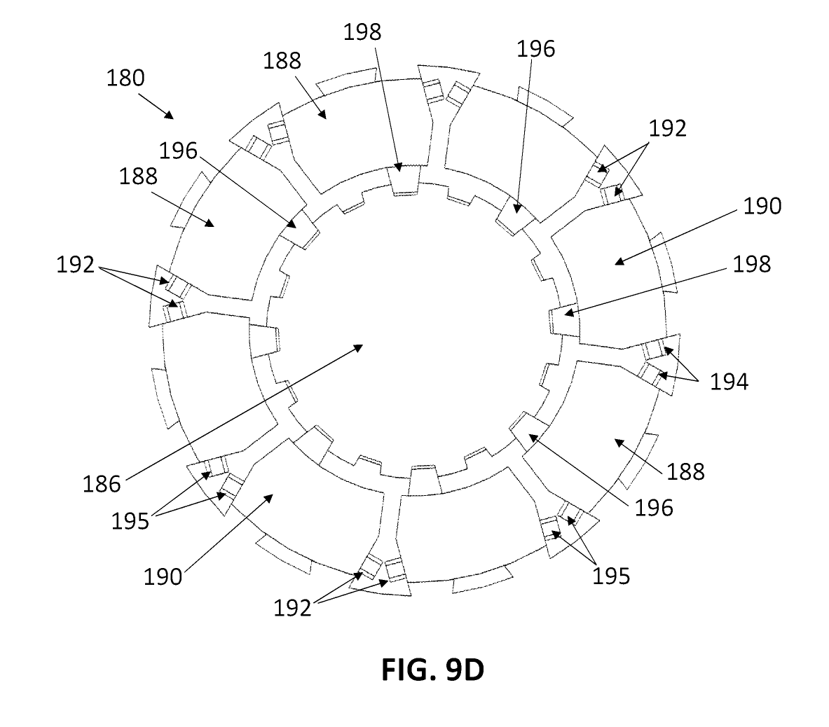

As shown in FIGS. 9A-9D, the medial connectors 180 are configured to maintain the position of the wheels 130 across the length of the roller 120. The medial connectors 180 are configured to be disposed along a length of the axle 126 between the first and second end connectors 140, 160. The medial connectors 180 may also be configured to operate as or otherwise define the portion of the conveying surface 112 between the first and second end connectors 140, 160. Each medial connector 180 is configured to connect to or otherwise couple with the two adjacent connectors 140, 160, 180 when the connectors 140, 160, 180 are disposed on the axle 126 such that the connectors 140, 160, 180 are substantially continuous. In some embodiments, the medial connectors 180 are configured to connect with adjacent connectors 140, 160, 180 via snap fitting and/or interference fitting.

Each medial connector 180 is substantially cylindrical with a first end 182 and a second end 184 opposite the first end 182. The medial connector 180 also includes an axle receiving passage 186 extending longitudinally through a center of the medial connector 180 from the first end 182 to the second end 184. The axle receiving passage 186 is sized, shaped, and configured to receive the axle 126 therethrough.

Each medial connector 180 includes a first connecting portion 200 near the first end 182, a second connecting portion 202 near the second end 184, and a medial portion 204 extending longitudinally between the first and second connecting portions 200, 202. When the medial connectors 180 are assembled on the conveyor 100, each first connecting portion 200 may face toward the first frame member 108 and each second connecting portion 202 may face toward the second frame member 110.

The first connecting portion 200 is configured to connect or otherwise couple with a connector 140, 160, 180 adjacent to the first end 182 of the medial connector 180 and to maintain the positions of wheels 130 therebetween. The second connecting portion 202 is configured to connect or otherwise couple with a connector 140, 160, 180 adjacent to the second end 184 of the medial connector 180 and to maintain the position of wheels 130 therebetween. The medial portion 204 is configured to define the outer surface 128 of the roller 120 between the first and second connecting portions 200, 202. In some embodiments, the medial portion 204 is substantially cylindrical. In still further embodiments, the medial portion 204 includes a material and/or coating on the outer surface such that the packages may be conveyed smoothly in both the conveying direction and the rotational direction of the wheels 130. However, it will be understood that the medial portion 204 may have any suitable shape or configuration.

In some embodiments, the medial portion 204 of each medial connector 180 is the same length. In other embodiments, the medial portions 204 of the medial connectors 180 may vary in length, such as to allow the roller 120 to be retrofit on pre-existing rollers of varying sizes.

The first and second connecting portions 200, 202 each include a plurality of wheel receiving cavities 188. The wheel receiving cavities 188 of the first and second connecting portions 200, 202 may be substantially similar to the wheel receiving cavities 148 of the first end connector 140 and/or the wheel receiving cavities 168 of the second end connector 160 with each wheel receiving cavity 188 having a wheel receiving portion 190 and two axle receiving portions 192 on either side of the wheel receiving portion 190.

In some embodiments, the wheel receiving cavities 188 of the first connecting portion 200 are substantially the same as the wheel receiving cavities 188 of the second connecting portion 202. For example, the axle receiving portions 152, 172, 192 of the first end connector 140, the second end connector 160, the first connecting portion 200 of the medial connectors 180, and the second connecting portion 202 of the medial connectors 180 are each grooves or channels substantially corresponding to a lengthwise half of the wheel axles 136 such that the two corresponding axle receiving portions 152, 172, 192 of each connected pair of connectors 140, 160, 180 substantially surround the wheel axles 136 disposed therebetween.

In other embodiments, the wheel receiving cavities 188 of the first connecting portion 200 are slightly different from the wheel receiving cavities 188 of the second connecting portion 202. For example, the wheel receiving cavities 188 of the second connecting portion 202 may be substantially similar to the wheel receiving cavities 148 of the first end connector 140 and the wheel receiving cavities 188 of the first connecting portion 200 are substantially similar to the wheel receiving cavities 168 of the second end connector 160. In such embodiments, the first connecting portions 200 of the medial connectors 180 are configured to couple with the second connecting portions 202 of the medial connectors 180 and the second end connector 160 and the second connecting portions 202 of the medial connectors 180 are configured to couple with the first connecting portions 200 of the medial connectors 180 and the first end connector 140.

In the illustrated embodiment, the wheel receiving cavities 188 of the second connecting portion 202 are substantially similar to the wheel receiving cavities 148 of the first end connector 140 and the wheel receiving cavities 188 of the first connecting portion 201 are substantially similar to the wheel receiving cavities 168 of the second end connector 160. The axle receiving portions 192 of the wheel receiving cavities 188 of the second connecting portion 202 each include a neck portion 194 configured to substantially retain a wheel axle 136 therein. Each neck portion 194 narrows the opening to the respective axle receiving portion 192 (e.g., near the second end 184) such that the wheel axle 136 may be received in the axle receiving portion 192 and such that the neck portion 194 may substantially prevent the wheel axle 136 from being removed from the axle receiving portion 192.

The first connecting portions 200 of the medial connectors 180 may be sized, shaped, and configured to correspond with the neck portions 154, 194 of the first end connector 140 and/or the second connecting portions 202. The axle receiving portions 192 of the wheel receiving cavities 188 of the first connecting portion 200 and/or the first connecting portion 200 may comprise a plurality of longitudinal projections 195 which may be partially received in the axle receiving portions 152, 172 of the corresponding connector 140, 180. The wheel axles 136 may be snap fit into the axle receiving portions 152, 192 of the first end connector 140 and/or the second connecting portion 202 of the medial connectors 180 via the neck portions 154, 194 and each longitudinal projection of the first connecting portions 200 may be partially received in one of the axle receiving portions 152, 192 of the corresponding connector 140, 180. The longitudinal projection 195 may substantially close the axle receiving portion 152, 192 of the other connector 140, 180 when the first connecting portion 200 is connected with the other connector 140, 160 such that the position of the wheel axle 136 may be substantially maintained during operation.

The first and second connecting portions 200, 202 of the medial connectors 180 may also have one or more components configured to couple the respective connecting portion 200, 202 to an adjacent connector 140, 160, 180. As shown in FIG. 8, the second connecting portion 202 of each medial connector 180 may include one or more longitudinal receiving portions 196 extending longitudinally into the second end 184 of the medial connector 180 and the first connecting portion 200 of each medial connector 180 may include one or more longitudinally extending projections 198 extending longitudinally away from the first end 182 of the medial connector 180. The longitudinal receiving portions 196 are configured to receive the longitudinal extending projections 178, 198 of the second end connector 160 and/or another medial connector 180 and the longitudinally extending projections 198 are configured to be received in the longitudinal receiving portions 156, 196 of the first end connector 140 and/or another medial connector 180. The longitudinal receiving portions 196 and the longitudinally extending projections 198 may be sized, shaped, and configured to permit the connectors 140, 160, 180 to be coupled together and to substantially prevent the connectors 140, 160, 180 from decoupling during operation of the roller 120, as described above.

While each first connecting portion 200 has been described as including a plurality of longitudinally extending projections 198 and each second connecting portion 202 has been described as including a plurality of longitudinal receiving portions 196, it will be understood that the roller 120 may have other suitable configurations. For example, the first connecting portions 200 may each include a plurality of longitudinal receiving portions 196 and the second connecting portions 202 may each include a plurality of longitudinally extending projections 198 or the first and second connecting portions 200, 202 may include both longitudinal receiving portions 196 and longitudinally extending projections 198.

While the connectors 140, 160, 180 have been described as connecting together or otherwise coupling with each other via longitudinal receiving portions 156, 196 and longitudinally extending projections 178, 198, it will be understood that the connectors 140, 160, 180 may have other suitable connection mechanisms. For example, the connectors 140, 160, 180 may couple together via clips or magnets, such as clips or magnets disposed near the outer surface of the connectors 140, 160, 180 and/or the connectors 140, 160, 180 may be coupled together with adhesive, fasteners, welding, magnets, or the like.

In some embodiments, the wheel receiving cavities 188 of the first connecting portion 200 are circumferentially offset from the wheel receiving cavities 188 of the second connecting portion 202 such that wheels 130 connected to the first connecting portion 200 are circumferentially offset from wheels 130 connected to the second connecting portion 202. In the illustrated embodiment, the wheel receiving cavities 188 of the first and second connecting portions 200, 202 are circumferentially offset such that the center of the wheel receiving portions 190 of the wheel receiving cavities 188 of the first connecting portion 200 substantially align with the axle receiving portions 192 of the wheel receiving cavities 188 of the second connecting portion 202 and vice versa. However, it will be understood that the wheel receiving cavities 188 of the first connecting portion 200 may have any suitable position relative to the wheel receiving cavities 188 of the second connecting portion 202.

In some embodiments, the wheel receiving cavities 188 of the first and second connecting portions 200, 202 are circumferentially offset from each other such that a plurality of wheels 130 are disposed at positions along the length of the roller 120 at each circumferential position around the roller 120 when the connectors 140, 160, 180 are connected or otherwise coupled. For example, the wheel receiving cavities 188 of the first and second connecting portions 200, 202 may be circumferentially offset such that a plurality of wheels 130 define at least part of the outer surface 128 for the roller 120 regardless of the rotational position of the roller 120 about the axle 126.

In some embodiments, the wheel receiving cavities 188 of the first connecting portion 200 are circumferentially offset from the wheel receiving cavities 188 of the second connecting portion 202 such that, when the second connecting portion 202 of a first medial connector 180 is connected to the first connecting portion 200 of a second medial connector 180, the wheel receiving cavities 188 of the first connecting portion 200 of the first medial connector 180 are circumferentially aligned with the wheel receiving cavities 188 of the second connecting portion 202 of the second medial connector 180. In other embodiments, the wheel receiving cavities 188 of the first connecting portion 200 are circumferentially offset from the wheel receiving cavities 188 of the second connecting portion 202 such that, when the second connecting portion 202 of a first medial connector 180 is connected to the first connecting portion 200 of a second medial connector 180, the wheel receiving cavities 188 of the first connecting portion 200 of the first medial connector 180 are not circumferentially aligned with the wheel receiving cavities 188 of the second connecting portion 202 of the second medial connector 180.

In some embodiments, the wheel receiving cavities 188 of the first connecting portion 200 are circumferentially offset the same amount from the wheel receiving cavities 188 of the second connecting portions 202 for all medial connectors 180. In other embodiments, the amount the wheel receiving cavities 188 of first connecting portion 200 are circumferentially offset from the wheel receiving cavities 188 of the second connecting portion 202 varies between the different medial connectors 180.

The wheel receiving cavities 188 of the first and second connecting portions 200, 202 are configured to correspond and mate with the wheel receiving cavities 148, 168, 188 of the adjacent connector 140, 160, 180 such that wheels 130 may be retained between the connectors 140, 160, 180 with a portion of each wheel 130 being disposed within one of the wheel receiving portions 150, 170, 190 of two adjacent cavities. Each of the wheel axles 136 may be retained in the axle receiving portions 152, 172, 192 of at least one of the connectors 140, 160, 180. In some embodiments, the first connecting portions 200 of each of the medial connectors 180 are configured to connect to or otherwise couple with the second connecting portions 202 of each of the medial connectors 180 and the first end connector 140 and the second connecting portions 202 of each of the medial connectors 180 are configured to connect to or otherwise couple with the first connecting portions 200 of each of the medial connectors 180 and the second end connector 160.

The roller 120 is configured such that each wheel axle 136 is retained in one of the axle receiving portion 152, 172, 192 of at least one of the connectors 140, 160, 180. In some embodiments, each wheel axle 136 is retained in the axle receiving portions 152, 172, 192 of both adjacent connectors 140, 160, 180. For example, the axle receiving portions 152, 172, 192 of each of the adjacent connectors 140, 160, 180 may be sized, shaped, and configured to receive about half of one of the wheel axles 136 lengthwise and the coupling of the connectors 140, 160, 180 may secure the wheel 130 and the wheel axle 136 in the respective wheel receiving cavities 148, 168, 188.

In other embodiments, each wheel axle 136 is substantially retained within the axle receiving portions 152, 172, 192 of only one connector 140, 160, 180. For example, such as in embodiments incorporating a neck portion 154, 194, each wheel axle 136 may be secured, such as via snap fitting or interference fitting, within one of the connectors 140, 160, 180. In such embodiments, the corresponding end of the adjacent connector 140, 160, 180 may be sized, shaped, and configured to further retain the wheel axle 136 within the other connector 140, 160, 180. For example, the corresponding end of the adjacent connector 140, 160, 180 may include a longitudinal projection 175, 195 extending longitudinally from the remainder of the connector 140, 160, 180 and configured to be at least partially received in the corresponding axle receiving portion 152, 172, 192 of the adjacent connector 140, 160, 180 to further retain the wheel axle 136 in the axle receiving portion 152, 172, 192.

The roller 120 may include any suitable number and/or combination of medial connectors 180. For example, the roller 120 may include a number of medial connectors 180 of the same or varying sizes to substantially cover the conveying surface of a pre-existing conveyor.

In some embodiments, adjacent rollers 120 have one or more medial connectors 180 having different lengths (e.g., having different medial portion 204 lengths) such that, when the connectors 140, 160, 180 of the rollers 120 are assembled, the wheels 130 of one roller 120 are longitudinally offset or spaced apart from the wheels 130 of the adjacent roller(s) 120. For example, the medial connectors 180 adjacent to the first end connector 140 and/or the second end connector 160 may have different lengths such that the wheels 130 nearest the first end connector 140 and/or the second end connector 160 of one roller 120 are offset from the wheels 130 nearest the first end connector 140 and/or the second end connector 160 of the adjacent roller(s) 120. In some embodiments, the other medial connectors 180 (e.g., the medial connectors 180 not adjacent to the first and second end connectors 140, 160) have substantially the same length such that the spacing between medial connectors 180 is substantially the same for all rollers 120. However, it will be understood that the conveyor 100 may have any suitable configuration and the wheels 130 of adjacent rollers 120 may have any suitable relative positions.

In some embodiments, the roller 120 also includes an inner tube 210 disposed radially between the axle 126 and the connectors 140, 160, 180. The inner tube 210 may increase the alignment and/or rigidity of the roller 120. The inner tube 210 may be sized, shaped, and configured such that the axle receiving passages 146, 166, 186 of the connectors 140, 160, 180 may snuggly fit around an outer surface of the inner tube 210, such as to maintain the relative position of the connectors 140, 160, 180. In some embodiments, the connectors 140, 160, 180 are pressed onto the outer surface of the inner tube 210 with a slight interference fit. In some embodiments, the inner tube 210 is also configured to rotate around the axle 126 (e.g., bearings are disposed radially between the axle 126 and the inner tube 210).

In some embodiments, an inner diameter of the inner tube 210 is variable or otherwise adjustable such that the roller 120 may be implemented on a pre-existing roller. For example, the inner diameter of the inner tube 210 may be adjustable such that the inner tube 210 may be placed over the axle of the pre-existing roller and the connectors 140, 160, 180 may be fit on the outer surface of the inner tube 210 as described such that the roller 120 may be implemented (e.g., retrofit) as part of a pre-existing conveyor. In some embodiments, the inner tube 210 comprises steel.

In some embodiments, each roller 120 includes a plurality of bearings disposed between the axle 126 and the outer surface 128 (e.g., between the axle 126 and the inner tube 210) such that the outer surface 128 may rotate about the axle 126. The bearings may be disposed at any suitable position to enable rotation of the outer surface 128 (including the connectors 140, 160, 180 and the wheels 130) relative to the axle 126, which may be fixed. In some embodiments, the bearings are disposed within the first and second end connectors 140, 160 radially between the axle 126 and the axle receiving passage 146, 166. However, if will be understood that the roller 120 may have other suitable configurations. For example, one or more bearings may be disposed within the medial connectors 180 radially between the axle 126 and the axle receiving passage 186.

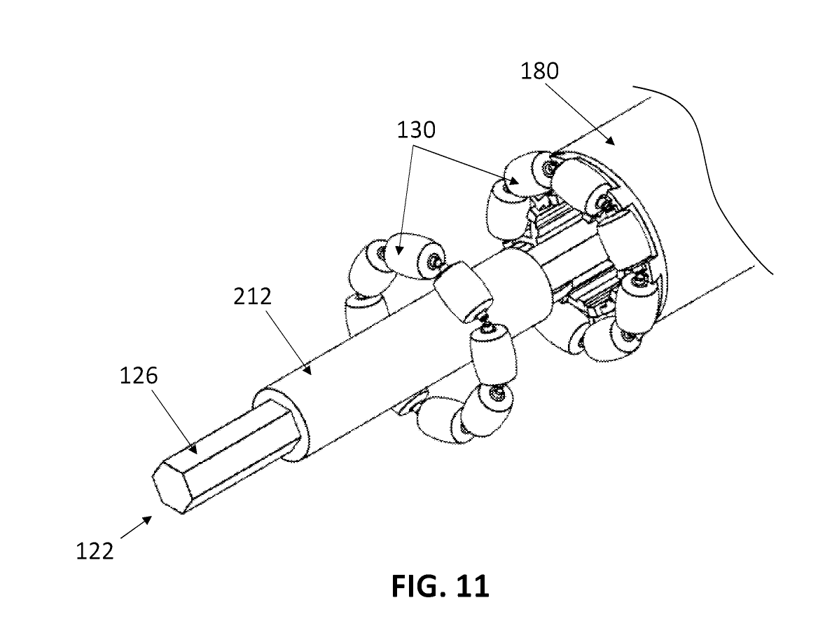

In some embodiments, as shown in FIG. 11, the roller 120 also includes one or more biasing elements 212 disposed radially between the axle 126 and one or more connectors 140, 160, 180. The biasing elements 212 are configured to maintain the longitudinal position of the respective connector 140, 160, 180 relative to the axle 126 and/or the inner tube 210. In some embodiments, one biasing element 212 is disposed radially between the axle 126 and the first end connector 140 and a second biasing element 212 is disposed radially between the axle 126 and the second end connector 160 such that the connectors 140, 160, 180 remain in place when connected on the axle 126. In some embodiments, the biasing elements 212 are springs.

While the roller 120 has been described as including an axle 126, a first end connector 140, a plurality of medial connectors 180, and a second end connector 160, it will be understood that the roller 120 may have other suitable configurations. For example, the described aspects of the roller 120 may be implemented with a pre-existing roller of a pre-existing conveyor by incorporating the above mentioned features upon the axle of the pre-existing roller. Accordingly, the wheels 130, the end connectors 140, 160, and the medial connectors 180 may be retrofit upon the axle of a pre-existing roller with a pre-existing drive mechanism without departing from the scope of this disclosure.

The connectors 140, 160, 180 may be formed from any suitable methods. In some embodiments, the connectors 140, 160, 180 are formed via injection molding.

The roller 120 may be assembled as part of a new conveyor or retrofit into a pre-existing conveyor. The first end connector 140 may be placed on the axle 126 (or pre-existing axle) near the first end 122 of the roller 120 and wheels 130 may be placed in each of the wheel receiving cavities 148 with the wheel axles 136 disposed (e.g., snap fit) into the respective axle receiving portions 152. The first connecting portion 200 of one of the medial connectors 180 may then be connected with the second end 144 of the first end connector 140. For example, the longitudinally extending projections 198 of the medial connector 180 may be received in the longitudinal receiving portions 156 of the first end connector 140 such that the wheel receiving cavities 188 of the medial connector 180 are aligned with the wheel receiving cavities 148 of the first end connector 140 and each wheel 130 is disposed in the wheel receiving portions 150, 190 of the two connectors 140, 180.

Wheels 130 may then be placed in each of the wheel receiving cavities 188 of the second connecting portion 202 of the medial connector 180 connected to the first end connector 140. The wheel axles 136 may be disposed (e.g., snap fit) into the respective axle receiving portions 192 of the second connecting portion 202. The second connecting portion 202 is then connected to the first connecting portion 200 of a second medial connector 180. For example, the longitudinally extending projections 198 of the first connecting portion 200 of the second medial connector 180 may be received in the longitudinal receiving portions 196 of the second connecting portion 202 of the first medial connector 180 such that the wheel receiving cavities 188 of the second connecting portion 202 of the first medial connector 180 are aligned with the wheel receiving cavities 188 of the first connecting portion 200 of the second medial connector 180 and each wheel 130 is disposed in the wheel receiving portions 190 of the two medial connectors 180. This process may be repeated as many times as necessary such that the first end connector 140 and the medial connectors 180 substantially fill the roller 120.

After the first end connector 140 and the medial connectors 180 are in place on the axle 126, wheels 130 may then be placed in each of the wheel receiving cavities 188 of the second connecting portion 202 of the last medial connector 180 (e.g., medial connector 180 farthest from the first end connector 140) as described above. The second connecting portion 202 is then connected to the second end connector 160. For example, the longitudinally extending projections 178 of the second end connector 160 may be received in the longitudinal receiving portions 196 of the last medial connector 180 such that the wheel receiving cavities 188 of the second connecting portion 202 of the last medial connector 180 are aligned with the wheel receiving cavities 168 of the second end connector 160 and each wheel 130 is disposed in the wheel receiving portions 170, 190 of both connectors 160, 180. The roller 120 then may be fixed in the conveyor 100 for operation.

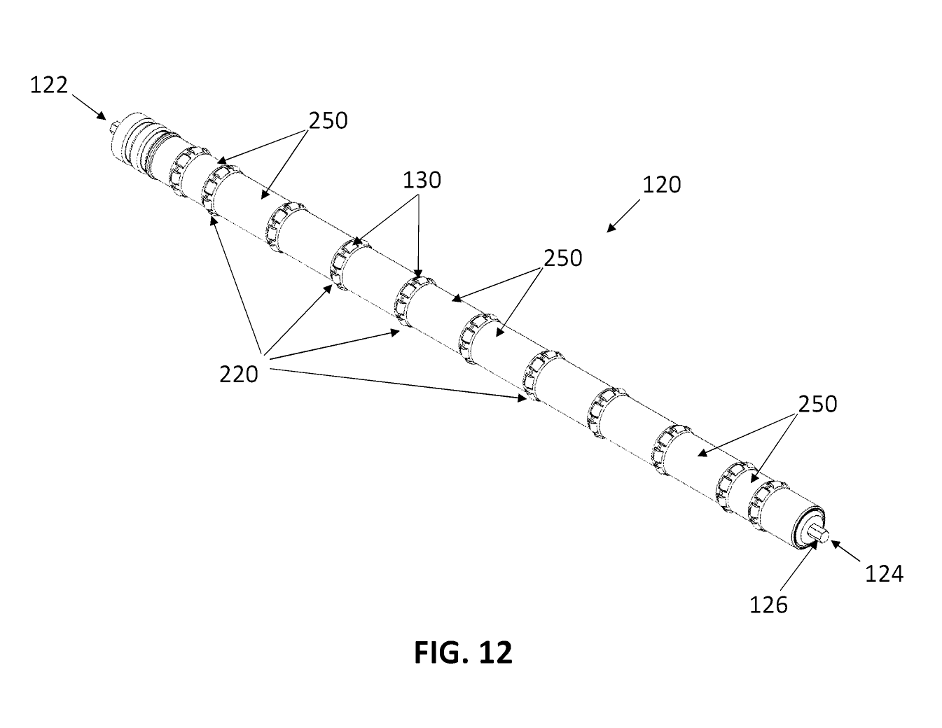

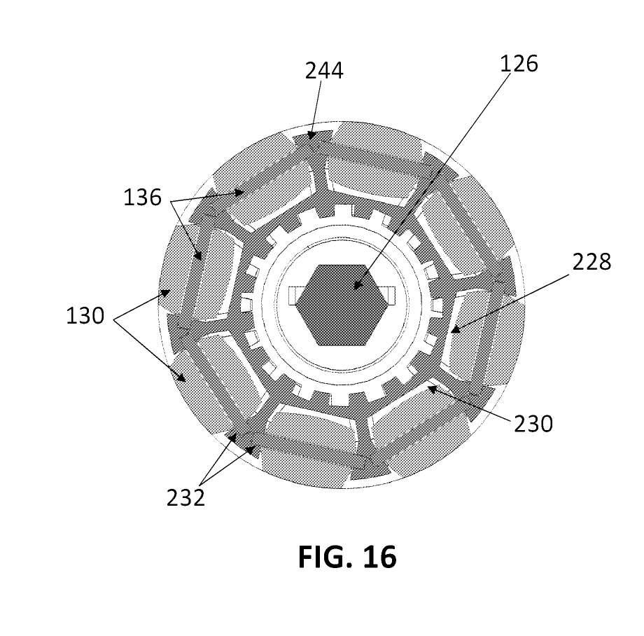

Referring now to FIGS. 12-19C, the bi-directional roller 120 is shown according to another embodiment. A plurality of the rollers 120 may be implemented into a conveyor, such as the conveyor of FIGS. 1-3, or one or more of the rollers 120 may be retrofit into a known or pre-existing conveyor, such as by modifying the rollers of the pre-existing conveyor. The bi-directional roller 120 may incorporate the any of the features discussed herein (and vice versa) unless explicitly discussed otherwise. For example, the roller 120 may be similar to the roller 120 shown in FIGS. 6A-11 except the wheels 130 may be contained in pre-assembled cartridges with the cartridges being spaced apart along the length of the roller 120 by a plurality of spacers.

The roller 120 extends from the first end 122 to the second end 124 and includes a plurality of cartridges 220 comprising a plurality of wheels 130 and a plurality of spacers 250 disposed between the cartridges 220. Each cartridge 220 maintains a plurality of wheels 130 in position around a circumference of the roller 120. The cartridges 220 retain the wheels 130 on the roller 120 such that the wheels 130 may rotate about an axis different than the rotational axis of the roller 120 (e.g., the axle 126), such as an axis perpendicular to the rotational axis of the roller 120. The spacers 250 may maintain the longitudinal positions of the cartridges 220 along the length of the roller 120. In some embodiments, the cartridges 220 and/or the spacers 250 are configured such that the wheels 130 are circumferentially offset along the length of the roller 120. In some embodiments, the cartridges 220 and/or the spacers 250 are configured such that the wheels 130 of one roller 120 are longitudinally offset from the wheels 130 of one or more adjacent rollers 120.

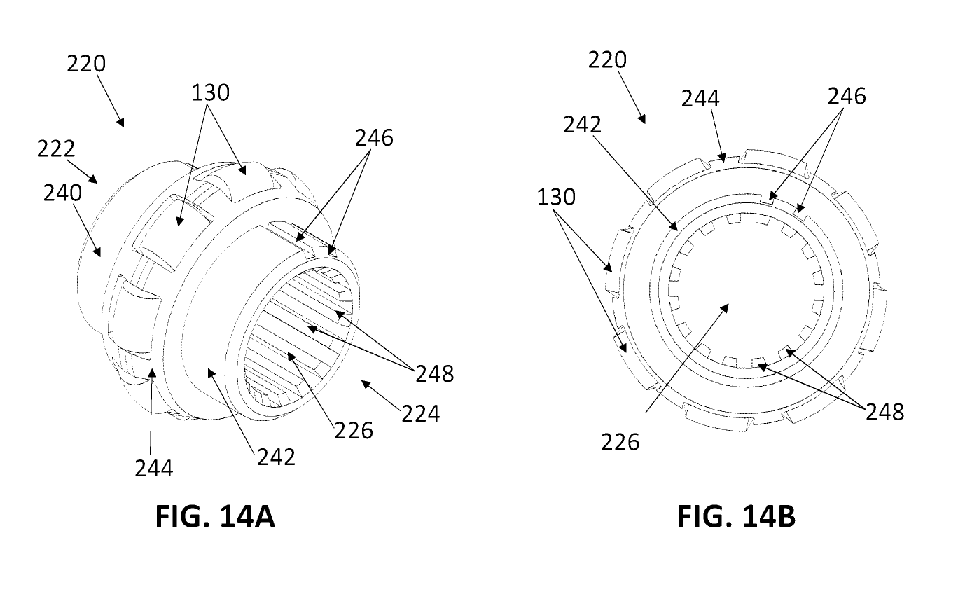

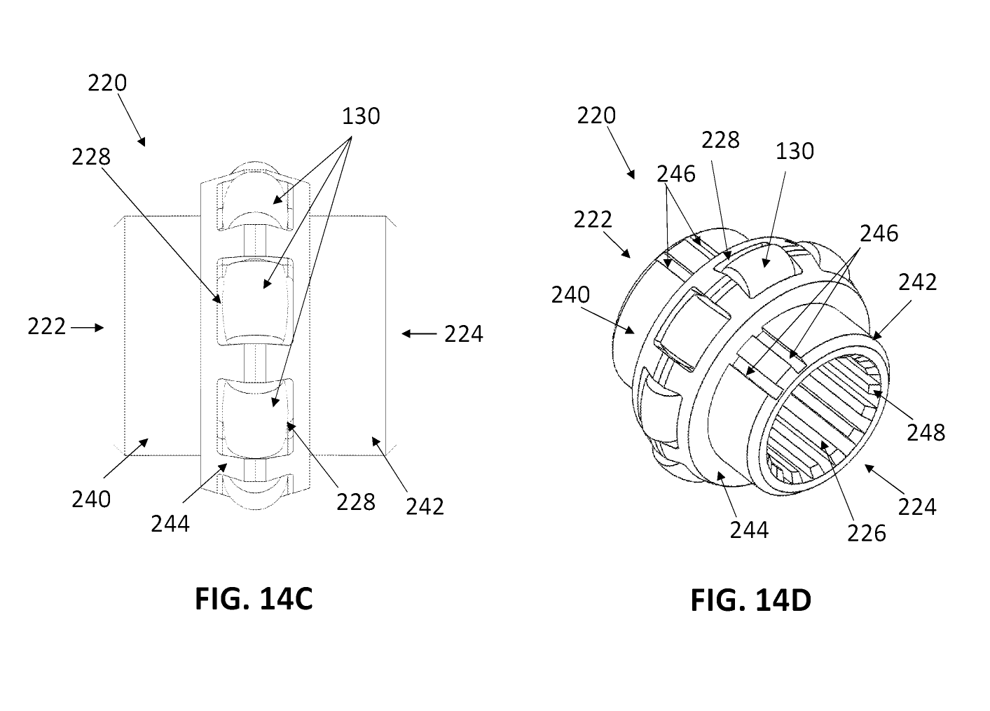

As shown in FIGS. 14A-14D, each cartridge 220 is configured to be disposed around the axle 126 along a length of the roller 120 and to house a plurality of wheels 130 such that the wheels 130 at least partially define the outer surface 128 of the roller 120. The cartridges 220 are generally cylindrical with a first end 222 and a second end 224 opposite the first end 222. The cartridges 220 also include an axle receiving passage 226 extending longitudinally through a center of the cartridge 220 from the first end 222 to the second end 224.

Each cartridge 220 includes a first coupling portion 240 disposed near the first end 222, a second coupling portion 242 disposed near the second end 224, and a housing portion 244 between the first and second coupling portions 240, 242. The housing portion 244 is configured to house a plurality of wheels 130 such that at least a portion of the wheels 130 define the outer surface 128 of the roller 120 and such that the wheels 130 may rotate about an axis different than the rotational axis of the roller 120 (e.g., the axle 126). In the illustrated embodiment, the wheels 130 are disposed in the housing portion 244 such that the wheels 130 are substantially perpendicular to the length of the roller 120. However, it will be understood that the wheels 130 may be oriented in the housing portion 244 in other suitable orientations.

In the illustrated embodiment, the housing portion 244 of each cartridge 220 houses eight wheels 130. However, it will be understood that the cartridges 220 may have other suitable configurations. For example, the cartridges 220 may house fewer than eight wheels or more than eight wheels 130 and/or the cartridges 220 may house differing numbers of wheels 130.

The first and second coupling portions 240, 242 are each configured to connect to or otherwise couple with one of the spacers 250, as detailed below. The first coupling portion 240 extends longitudinally outward from the housing portion 244 toward the first end 222 and the second coupling portion 242 extends longitudinally outward from the housing portion 244 toward the second end 224 such that spacers 250 may be coupled with both sides of the cartridge 220. The first and second coupling portions 240, 242 extend radially to a height less than the housing portion 244 such that the spacers 250 may be fit radially over the first and second coupling portions 240, 242. In some embodiments, the first and second coupling portions 240, 242 extend radially to a height relative to the housing portion 244 such that the outer surface of the spacers 250 are substantially continuous with the outer surface of the housing portion 244 when the spacers 250 are coupled with the first and second coupling portions 240, 242.

In some embodiments, the first and second coupling portions 240, 242 each include one or more retention grooves 246 for coupling with one of the spacers 250. The retention grooves 246 may be positioned and configured to maintain the rotational position of the spacers 250 connected to the respective coupling portion 240, 242. The retention grooves 246 are configured to receive at least portion of one of the spacers 250 to maintain the rotational position of the spacers 250. The retention grooves 246 may be grooves or channels extending along an outer surface of the coupling portions 240, 242 from the respective end 222, 224. In some embodiments, the retention grooves 246 extend substantially along the length of the coupling portions 240, 242 (e.g., between the housing portion 244 and the respective end 222, 224) such that the rotational position of the respective spacer 250 may be maintained along the length of the coupling portion 240, 242 and when the spacer 250 abuts the housing portion 244.

In the illustrated embodiment, the first and second coupling portions 240, 242 each include two retention grooves 246 in close radial proximity. However, it will be understood that the coupling portions 240, 242 may have other suitable configurations. For example, the coupling portions 240, 242 may include one or three or more retentions grooves 246 and the retention grooves 246 may be disposed at any suitably locations around the coupling portions 240, 242. In some embodiments, the retention grooves 246 of the first coupling portion 240 are circumferentially offset from the retention grooves 246 of the second coupling portion 242, such as described below.

The housing portion 244 of each cartridge 220 is configured to house each wheel 130 on a wheel axle 136 such that the wheels 130 may rotate substantially freely around the respective wheel axle 136. The housing portion 244 includes a plurality of wheel receiving cavities 228 extending radially inward from an outer surface of the housing portion 244 and configured to receive one of the pairs of wheels 130 and wheel axles 136. The housing portion 244 may be configured to retain the position of the wheel axles 136 within the wheel receiving cavities 228 (e.g., radially inward from the outer surface of the housing portion 244) such that a portion of each wheel 130 extends radially outward from the housing portion 244 and such that the wheel axles 136 remain in place during operation of the roller 120.

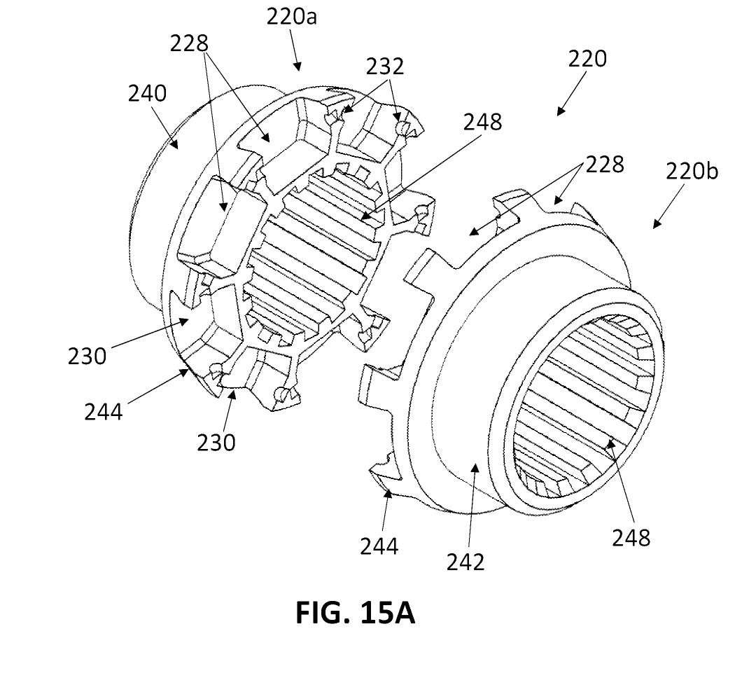

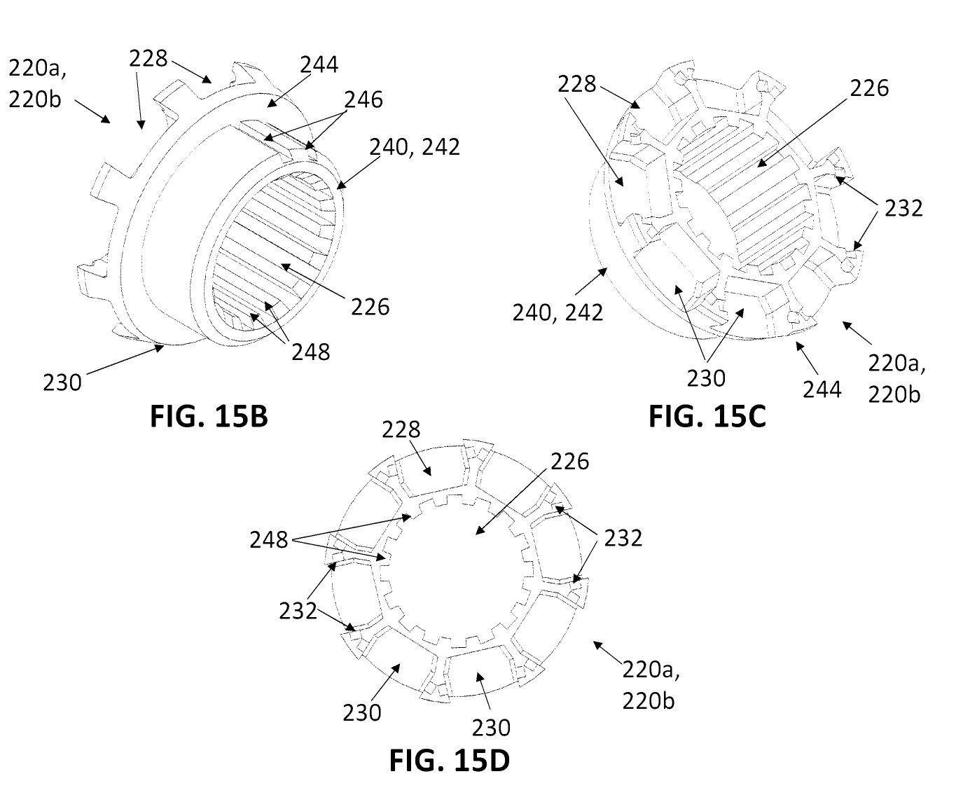

As shown in FIGS. 15A-15D, in some embodiments, each cartridge 220 is formed from a first cartridge half 220a and a second cartridge half 220b which may be assembled to form the cartridge 220. The first cartridge half 220amay comprise or otherwise define the first coupling portion 240 and half of the housing portion 244 and the second cartridge half 220b may comprise or otherwise define the second coupling portion 242 and the other half of the housing portion 244. The first cartridge half 220aand the second cartridge half 220b may be coupled together with the wheels 130 and the wheel axles 136 therebetween to form the cartridge 220. In some embodiments, the first and second cartridge halves 220a, 220b are coupled together via a snap fit or interference fit. However, it will be understood that the cartridge halves 220a, 220b may be coupled together by other suitable means. For example, the first and second cartridge halves 220a, 220b may be coupled together via clips, adhesive, fasteners, welding, magnets, or the like.

In some embodiments, the portions of the first and second cartridge halves 220a, 220b defining the housing portion 244 are substantially mirror images of each other. Each of the cartridge halves 220a,220b includes a plurality of wheel receiving cavities 228. Each wheel receiving cavity 228 includes a wheel receiving portion 230 and axle receiving portions 232 on either side of the wheel receiving portion 230 (e.g., circumferentially). The wheel receiving portion 230 is configured to partially receive one of the wheels 130 and the axle receiving portions 232 are configured to partially receive the wheel axle 136 of the wheel 130 disposed partially within the wheel receiving cavity 228. The wheel receiving portion 230 is in communication with the two corresponding axle receiving portions 232 such that the wheel 130 and the wheel axle 136 may be received in the wheel receiving cavity 228 when the wheel axle 136 is inserted through the wheel axle passage 134 of the wheel 130.

Each wheel receiving portion 230 is sized, shaped, and configured to at least partially receive one of the wheels 130 therein such that a portion of the wheel 130 extends radially out of the wheel receiving portion 230 and such that the wheel 130 may rotate when the wheel 130 is at least partially disposed in the wheel receiving portion 230. The wheel receiving portion 230 may have a size and shape slightly larger than the portion of the wheel 130 to be received therein such that the wheel 130 may rotate substantially freely about the wheel axle 136 in the wheel receiving portion 230 without contacting the cartridge half 220a, 220b (e.g., the walls of the wheel receiving portion 230).

In some embodiments, each wheel receiving portion 230 is configured to receive about half of one of the wheels 130 lengthwise within the wheel receiving portion 230. Each wheel receiving portion 230 may have a length about the same as or slightly larger than the longitudinal length of the respective wheel 130 and may have a depth extending toward the respective coupling portion 240, 242 about the same distance as or slightly larger than a radius of the respective wheel 130. In some embodiments, the wheel receiving portion 230 may have a shape substantially corresponding to the shape of the wheel 130. For example, the wheel receiving portion 230 may be rounded and have a curvature corresponding to the shape of the portion of the wheel 130 disposed therein. However, it will be understood that the wheel receiving portions 230 may have any suitable shapes.

The axle receiving portions 232 may be slightly radially inset from the radial outer surface of the cartridge half 220a, 220b such that the wheels 130 may extend radially outward from the wheel receiving cavities 228 when the wheels 130 are coupled with the wheel axles 136 disposed at least partially within the axle receiving portions 152, such as described below.

In the illustrated embodiment, the axle receiving portions 232 are semi-circular or rounded grooves extending into end of the cartridge half 220a, 220b. However, it will be understood that the axle receiving portions 232 may have any suitable size, shape, and configuration. For example, the axle receiving portions 232 may be rectangular grooves extending into the first end.

The wheel receiving cavities 228 may each be sized, shaped, and configured to maintain the respective wheel 130 in an operative position during operation of the roller 120. For example, the wheel receiving portions 230 may be sized, shaped, and configured such that each wheel 130 remains within the respective wheel receiving portion 230 and the wheel axle 136 remains at least partially within each of the respective pair of axle receiving portions 232 when the cartridge halves 220a, 220b are joined together. Each wheel receiving cavity 228 may have a width (e.g., combined width of the wheel receiving portion 230 and the axle receiving portions 230) which substantially retains the wheel 130 and wheel axle 136 within the wheel receiving cavity 228. In some embodiments, each wheel axle 136 has a length along a longitudinal axis of the wheel axle 136 that is greater than a combined width of the wheel receiving portion 230 and one of the axle receiving portions 232 such that lateral movement of the wheel axle 136 within the wheel receiving cavity 228 does not cause the wheel 130 and wheel axle 136 to fall out of the wheel receiving cavity 228. In still further embodiments, the wheel receiving cavity 228 has a width substantially the same as or slightly larger than the length of the respective wheel axle 136.

Each axle receiving portion 232 may be sized, shaped, and configured to at least partially maintain the wheel axle 136 within the axle receiving portion 232 when the cartridge halves 220a, 220b are joined together. Each axle receiving portion 232 may be sized, shaped, or configured such that the wheel axle 136 may be held or otherwise maintained in the corresponding axle receiving portions 232 of each of the cartridge halves 220a, 220b and prevented or otherwise restricted from being removed from the axle receiving portions 232 when the first cartridge half 220a is connected to the second cartridge half 220b. The wheel receiving cavities 228 of the first cartridge half 220a align substantially with the wheel receiving cavities 228 of the second cartridge half 220b such that each pair of wheels 130 and wheel axles 136 may be partially retained in one of the wheel receiving cavities 228 of each of the cartridge halves 220a, 220b.

While the first and second cartridge halves 220a, 220b have been described as being substantial mirror images of each other, it will be understood that the cartridge halves 220a, 220b may have other suitable configurations. For example, one of the cartridge halves 220a, 220b may have a neck portion in the axle receiving portions 232 such that the wheel axle 136 may be substantially retained in the cartridge half 220a, 220b and the other cartridge half 220a, 220b may have a plurality of longitudinal projections which may substantially close the axle receiving portion 232 when the cartridge halves 220a, 220b are connected, as described above. Additionally, the cartridge halves 220a, 220b may have one or more longitudinal receiving portions and/or one or more longitudinally extending portions, as discussed above, which may interlock when the cartridge halves 220a, 220b are combined to further couple the cartridge halves 220a, 220b together.

While the cartridges 220 have been described as being formed of two cartridge halves 220a, 220b it will be understood that the cartridges 220 may have other suitable configurations. For example, the cartridges 220 may be formed as an integral piece.

In some embodiments, the cartridge 220 includes a plurality of fins 248 extending radially inwardly from an inner surface of the cartridge 220 defining the axle receiving passage 226. The fins 248 may be sized, shaped, spaced, and configured to securely fit the cartridge 220 on the axle 126 and/or the inner tube 210. In some embodiments, the fins 248 are substantially the same size and shape and are evenly spaced around the inner surface of the cartridge 220 defining the axle receiving passage 226. However, it will be understood that the cartridge 220 may have other suitable configurations.

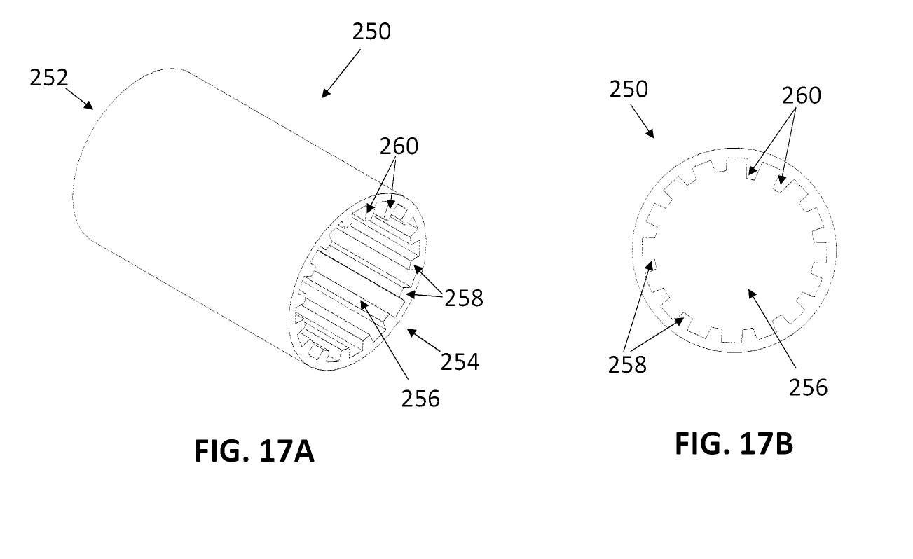

Referring now to FIGS. 17A-20C, the spacers 250 are configured to couple with the coupling portions 240, 242 of the cartridges and to space the cartridges 220 apart along the length of the roller 120. In some embodiments, the spacers 250 are configured to circumferentially (e.g., rotationally) offset adjacent cartridges 220.

Each spacer 250 is substantially tubular having a first end 252 and a second end 254 opposite the first end 252. Each spacer 250 also includes an axle receiving passage 256 extending longitudinally through a center of the spacer 250 from the first end 252 to the second end 254. The outer surface of each of the spacers 250 is substantially smooth and is configured to define a portion of the outer surface 128 of the roller 120.

Each spacer 250 is configured to be longitudinally inserted onto the one of the coupling portions 240, 242 of two adjacent cartridges 220 such that the outer surface of the spacer 250 substantially defines the outer surface 128 of the roller 120 between the housing portions 244 of the adjacent cartridges 220. For example, the first end 252 of the spacer 250 may be disposed on the second coupling portion 242 of a first cartridge 220 and the second end 254 of the spacer 250 may be disposed on the first coupling portion 240 of a second cartridge 220.

The inner radial surface of the spacers 250 defining the axle receiving passage 256 may include a plurality of fins 258 extending radially inwardly toward a center of the spacer 250. The fins 258 may be sized, shaped, spaced, and configured to securely fit the spacer 250 onto the respective coupling portion 240, 242 of adjacent cartridges 220. In some embodiments, the fins 258 are substantially the same size and shape and are generally evenly spaced around the inner surface of the spacer 250 defining the axle receiving passage 256. However, it will be understood that the spacer 250 may have other suitable configurations.

In some embodiments, the inner radial surface of each spacer 250 also includes one or more radial protrusions 260 extending radially inward toward a center of the spacer 250. The radial protrusions 260 extend radially inward to a distance greater than the fins 258 and may each correspond to one of the retention grooves 246 of the coupling portions 240, 242 of the cartridges 220.

Each of the radial protrusions 260 is configured to be received in one of the retention grooves 246 such that the rotational position of the spacer 250 may be maintained relative to the rotational position of the coupled cartridge 220. For example, when the radial protrusions 260 are disposed in the retention grooves 246 of the second coupling portion 242 of a first cartridge 220 and are also disposed in the retention grooves 246 of the first coupling portion 240 of a second cartridge 220 the relative rotational positions of the spacer 250 and the two cartridges 220 may be maintained, such as during operation of the roller 120. In some embodiments, the fins 258 and the radial protrusions 260 are sized, shaped, and configured such that the spacer 250 cannot be disposed on the coupling portion 240, 242 of one of the cartridges 220 unless the radial protrusions 260 are disposed in the retention grooves 246 of the cartridge 220.

In the illustrated embodiment, the spacer 250 includes two radial protrusions 260 in close radial proximity. However, it will be understood that the spacer 250 may have other suitable configurations. For example, the spacer 250 may include any number of radial protrusions 260 in any configuration corresponding to the retention grooves 246 of the cartridges 220.

In some embodiments, the radial protrusions 260 are substantially linear within the spacer 250. In other embodiments, the radial protrusions 260 curve or twist within the spacer 250 such that circumferential position of the radial protrusions 260 at the first end 252 is different from the circumferential position of the radial protrusions 260 at the second end 254.

The spacers 250 may have any suitable length and any combination of spacers 250 may be combined on the roller 120. In some embodiments, the lengths of the spacers 250 are selected such that the cartridges 220 and/or wheels 130 of adjacent rollers 120 are longitudinally offset, as described above. In some embodiments, the spacers 250 are customizable and each spacer 250 may be cut to a desired length, such as to retrofit the roller 120 onto a pre-existing conveyor.

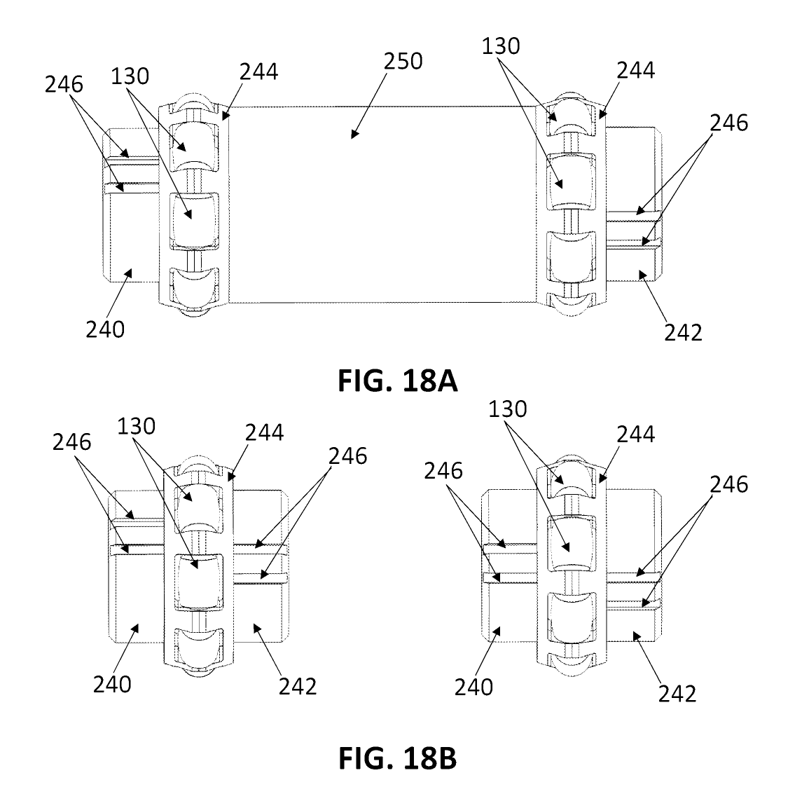

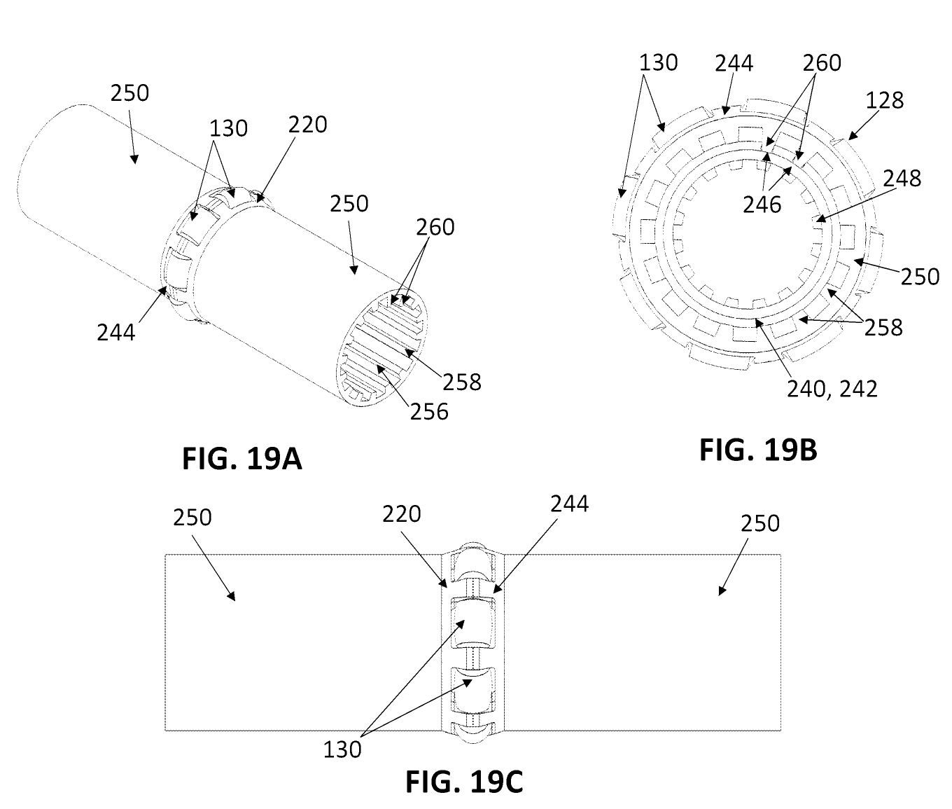

As shown in FIGS. 18A-19C, the spacers 250 may be coupled with the cartridges 220 to form the roller 120. The second end 254 of a first spacer 250 may be disposed on the first coupling portion 240 (e.g., with the radial protrusions 260 received in the retention grooves 246) of a first cartridge 220 and the first end 252 of a second spacer 250 may be disposed on the second coupling portion 242 (e.g., with the radial protrusions 260 received in the retention grooves 246) of a second cartridge 220. The second end 254 of the second spacer 250 may then be disposed on the first coupling portion 240 of a second cartridge 220. The process may be repeated until the cartridges 220 and spacers 250 substantially fill the roller 120 and define the outer surface 128 of the roller 120. The housing portions 244 of the cartridges 220 may extend radially beyond the outer surface of the spacers 250 such that packages disposed on the roller 120 may be moved along the wheels 130 in the cartridges 220.

In some embodiments, the spacers 250 are coupled with the cartridges 220 such that the wheels 130 of adjacent cartridges 220 are circumferentially offset. As shown in FIGS. 18A and 18B (the spacer 250 has been removed in FIG. 18B), the roller 120 may be configured such that the retention grooves 246 of the first coupling portion 240 of each cartridge 220 are circumferentially offset from the retention grooves 246 of the second coupling portion 242. The radial protrusions 260 of the spacer 250 may be received in the retention grooves 246 of the respective coupling portions 240, 242 of the two adjacent cartridges 220 such that the two adjacent coupling portions 240, 242 (e.g., the coupling portions 240, 242 facing each other) are substantially aligned. Due to the retention grooves 246 of the first and second coupling portions 240, 242 being circumferentially offset for each cartridge 220, the wheels 130 of the cartridges 220 joined by the spacer 250 are equally offset.

The spacer 250 maintains the relative rotational positions of the two cartridges 220. As such, the wheels 130 of the roller 120 may be circumferentially offset around the outer surface 128 of the roller 120 such that packages may be disposed on one or more wheels regardless of the rotational position of the roller 120. In some embodiments, the retention grooves 246 of the first coupling portion 240 are circumferentially offset from the retention grooves 246 of the second coupling portion 242 such that the center of the wheels 130 of one of the cartridges 220 substantially aligns with the axle receiving cavities 232 of adjacent cartridges 220. However, it will be understood that the wheels 130 of adjacent cartridges 220 may be circumferentially offset by any suitable amount.

In some embodiments, the cartridges 220 and/or the spacers 250 are formed by injection molding.

In some embodiments, the roller 120 also includes an inner tube 210 disposed radially between the axle 126 and cartridges 220 and the spacers 250, as described above. The inner tube 210 may increase the alignment and/or rigidity of the roller 120. The inner tube 210 may be sized, shaped, and configured such that the axle receiving passages 226 of the cartridges 220 (and the axle receiving passages 256 of the spacers 250) may snuggly fit around an outer surface of the inner tube 210, such as to maintain the relative position of the cartridges (and spacers 250). In some embodiments, the cartridges 220 (and spacers 250) are pressed onto the outer surface of the inner tube 210 with a slight interference fit. In some embodiments, the inner tube 210 is also configured to rotate around the axle 126 (e.g., bearings are disposed radially between the axle 126 and the inner tube 210).

In some embodiments, each roller 120 includes a plurality of bearings disposed between the axle 126 and the outer surface 128 (e.g., between the axle 126 and the inner tube 210), as described above, such that the outer surface 128 may rotate about the axle 126. The bearings may be disposed at any suitable position to enable rotation of the outer surface 128 (including cartridges 220, the spacers 250, and the wheels 130) relative to the axle 126, which may be fixed.

In some embodiments, the roller 120 also includes one or more biasing elements 212 disposed radially between the axle 126 and one or more cartridges 220, as described above. The biasing elements 212 are configured to maintain the longitudinal position of the respective cartridge 220 relative to the axle 126 and/or the inner tube 210. In some embodiments, the biasing elements 212 are springs.

While the roller 120 has been described as including an axle 126, a plurality of cartridges 220, and a plurality of spacers 250, it will be understood that the roller 120 may have other suitable configurations. For example, the described aspects of the roller 120 may be implemented with a pre-existing roller of a pre-existing conveyor by incorporating the above mentioned features upon the axle of the pre-existing roller. Accordingly, the cartridges 220 and spacers 250 may be retrofit upon the axle of a pre-existing roller with a pre-existing drive mechanism without departing from the scope of this disclosure. Additionally, the roller 120 may incorporate any of the features of the previous roller, such as the drive mechanism, without departing from the scope of this disclosure.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A conveyor comprising:
a first frame member;
a second frame member; and
a plurality of rollers disposed between the first frame member and the second frame member and defining a conveying surface, wherein the plurality of rollers comprises a roller having an axis of rotation extending along a length of the roller, the roller comprising wheels disposed at positions along the length of the roller;
wherein axes of rotation of the wheels are perpendicular to the axis of rotation of the roller; and
wherein adjacent wheels along the length of the roller are circumferentially offset relative to each other.

2. The conveyor of claim 1, wherein the wheels are disposed partially within an outer surface of the roller and extend partially radially beyond the outer surface of the roller such that the wheels at least partially define part of the conveying surface.

3. The conveyor of claim 1, wherein the roller comprising the wheels is retrofit onto the conveyor.

4. The conveyor of claim 1, the roller comprising a plurality of wheels disposed circumferentially around the roller at one or more of the positions along the length of the roller.

5. The conveyor of claim 1, the roller comprising:
a first end connector having a plurality of wheel receiving cavities;
a second end connector having a plurality of wheel receiving cavities; and
a plurality of medial connectors disposed between the first end connector and the second end connector along the length of the roller, each medial connector having a first connecting portion with a plurality of wheel receiving cavities, a second connecting portion with a plurality of wheel receiving cavities, and a medial portion disposed between the first connecting portion and the second connecting portion;
wherein adjacent connectors are connected along the length of the roller with adjacent wheel receiving cavities being aligned; and
wherein the wheels are disposed in the aligned pairs of wheel receiving cavities.

6. The conveyor of claim 5, the roller further comprising an inner tube extending through each of the first end connector, the second end connector, and the plurality of medial connectors.

7. The conveyor of claim 5, wherein adjacent connectors are snap fit together.

8. The conveyor of claim 5, the roller further comprising a biasing element disposed radially within at least one of the first end connector and the second end connector.

9. The conveyor of claim 1, the roller comprising:
a plurality of cartridges each having a first coupling portion, a second coupling portion, and a housing portion comprising one or more of the wheels; and
a plurality of spacers;
wherein the spacers couple one of the coupling portions of adjacent cartridges to each other.

10. The conveyor of claim 9, wherein a length of each spacer is variable.

11. A roller for bi-directional conveyance in a conveyor system, the roller comprising:
wheels disposed at positions along a length of the roller;
wherein the roller has an axis of rotation extending along the length of the roller;
wherein axes of rotation of the wheels are perpendicular to the axis of rotation of the roller; and
wherein adjacent wheels along the length of the roller are circumferentially offset relative to each other.

12. The roller of claim 11, wherein the wheels are disposed partially within an outer surface of the roller and extend partially radially beyond the outer surface of the roller.

13. The roller of claim 11, further comprising a plurality of wheels disposed circumferentially around the roller at one or more of the positions along the length of the roller.

14. The roller of claim 11, further comprising:
a first end connector having a plurality of wheel receiving cavities;
a second end connector having a plurality of wheel receiving cavities; and
a plurality of medial connectors disposed between the first end connector and the second end connector along the length of the roller, each medial connector having a first connecting portion with a plurality of wheel receiving cavities, a second connecting portion with a plurality of wheel receiving cavities, and a medial portion disposed between the first connecting portion and the second connecting portion;
wherein adjacent connectors are connected along the length of the roller with adjacent wheel receiving cavities being aligned; and
wherein the wheels are disposed in the aligned pairs of wheel receiving cavities.

15. The roller of claim 14, further comprising an inner tube extending through each of the first end connector, the second end connector, and the plurality of medial connectors.

16. The roller of claim 14, wherein adjacent connectors are snap fit together.

17. The roller of claim 14, further comprising a biasing element disposed radially within at least one of the first end connector and the second end connector.

18. The roller of claim 14, wherein the wheel receiving cavities of at least one of the connectors includes a neck portion configured to retain a wheel axle within axle receiving portions.

19. The roller of claim 11, further comprising:
a plurality of cartridges each having a first coupling portion, a second coupling portion, and a housing portion comprising one or more of the wheels; and
a plurality of spacers;
wherein the spacers couple one of the coupling portions of adjacent cartridges to each other.

20. The roller of claim 19, wherein a length of each spacer is variable.
